(19) United States
(12) Patent Application Publication
(10) Pub. No.: US 2022/0108235 A1
(43) Pub. Date: Apr. 7, 2022

(54) Systems and Methods for Accounting for Uncertainty in Ride-Sharing Transportation Services

(71) Applicant: c/o Uber Technologies, Inc., San Francisco, CA (US)

(72) Inventors: Karl Weston Schulz, Long Island City, NY (US); Lettitia Elfreda Clarke, Brooklyn, NY (US); Kellen Christopher Mollahan, Summit, NJ (US)

(21) Appl. No.: 17/493,349

(22) Filed: Oct. 4, 2021

Related U.S. Application Data
(60) Provisional application No. 63/086,770, filed on Oct. 2, 2020.

(51) Int. Cl. G06Q 10/02; G06Q 50/30; G01C 21/34

(52) U.S. Cl. CPC G06Q 10/025; G01C 21/3423; G06Q 50/30

(57) ABSTRACT

A computing system is provided. The computing system is configured to obtain an initial candidate multi-modal transportation itinerary for a user. The computing system is configured to determine an uncertainty associated with a first leg of the initial candidate multi-modal transportation itinerary. The computing system is configured to determine one or more modifications to the initial candidate multi-modal transportation itinerary based, at least in part, on the uncertainty associated with the first leg. The computing system is configured to generate an updated candidate multi-modal transportation itinerary for the user based, at least in part, on the one or more modifications to the initial candidate multi-modal transportation itinerary. The computing system is configured to communicate data associated with the updated candidate multi-modal transportation itinerary to a user device.

### RELATED APPLICATION

The present application is based on and claims the benefit of U.S. Provisional Patent Application No. 63/086,770 having a filing date of Oct. 2, 2020, which is incorporated by reference herein.

### FIELD

The present disclosure relates generally to ride-sharing transportation services. More particularly, the present disclosure relates to intelligently evaluating uncertainty to help generate multi-modal ride-sharing itineraries for users and vehicles.

### BACKGROUND

A wide variety of modes of transport are available within cities. For example, people can walk, ride a bike, drive a car, take public transit, or use a ride sharing service. However, as population densities and demand for land increase, many cities are experiencing problems with traffic congestion and the associated pollution. Consequently, there is a need to expand the available modes of transport in ways that can reduce the amount of traffic without requiring the use of large amounts of land.

Air travel, water travel, and underground travel within cities can reduce travel time over purely ground-based approaches and alleviate problems associated with traffic congestion. Multi-modal itineraries that combine a number of different transportation modalities provide opportunities to expand transport networks for cities and metropolitan areas. However, the transfer from one modality to another can present technical problems.

### SUMMARY

Aspects and advantages of embodiments of the present disclosure will be set forth in part in the following description, or may be learned from the description, or may be learned through practice of the embodiments.

In one example aspect, a computing system is provided. The computing system includes one or more processors and one or more non-transitory computer-readable media. The one or more non-transitory computer-readable media collectively store instructions that, when executed by the one or more processors, cause the computing system to perform operations. The operations include obtaining an initial candidate multi-modal transportation itinerary for a user. The initial candidate multi-modal transportation itinerary includes a first leg and a second leg. The operations include determining an uncertainty associated with the first leg of the initial candidate multi-modal transportation itinerary and further determining one or more modifications to the initial candidate multi-modal transportation itinerary based, at least in part, on the uncertainty associated with the first leg. The operations include generating an updated candidate multi-modal transportation itinerary for the user based, at least in part, on the one or more modifications to the initial candidate multi-modal transportation itinerary. The operations include communicating data associated with the updated candidate multi-modal transportation itinerary to a user device.

In another example aspect, a computer-implemented method is provided. The method includes obtaining, by a computing system including one or more computing devices, multi-modal transportation data associated with a multi-modal transportation service. The multi-modal transportation data includes data associated with a multi-modal transportation itinerary for a user. The multi-modal transportation itinerary includes a first leg and a second leg. The first leg includes a first transportation service for a user to a departing transportation node from an origin location. The method includes determining an uncertainty associated with an estimated time-of-arrival of the user at the departing transportation node based, at least in part, on the multi-modal transportation data. The method includes determining one or more modifications to the multi-modal transportation itinerary for the user based, at least in part, on the uncertainty associated with the estimated time-of-arrival. The method includes communicating one or more command signals associated with updating the multi-modal transportation itinerary according to the one or more modifications.

In yet another example aspect, one or more tangible, non-transitory computer readable media storing instructions is provided. When the instructions are executed by one or more processors, the instructions cause the one or more processors to perform operations. The operations include obtaining an initial candidate multi-modal transportation itinerary for a user. The initial candidate multi-modal transportation itinerary includes a first leg, a second leg, and a third leg. The first leg includes a first transportation service associated with transporting the user from an origin location to a departing transportation node. The second leg includes a second transportation service associated with transporting the user from the departing transportation node to a destination transportation node. The third leg includes a third transportation service associated with transporting the user from the destination transportation node to a destination location. The operations include determining an uncertainty associated with at least one leg of the initial candidate multi-modal transportation itinerary. The operations include determining one or more modifications to the initial candidate multi-modal transportation itinerary based, at least in part, on the uncertainty associated with the at least one leg of the initial candidate multi-modal transportation itinerary. The one or more modifications include adjusting a type of transportation modality associated with the first ground-based transportation service or the second ground-based transportation service. The operations include generating an updated candidate multi-modal transportation itinerary for the user based, at least in part, on the one or more modifications to the initial candidate multi-modal transportation itinerary. The operations include communicating data associated with the updated candidate multi-modal transportation itinerary to a user device.

Other example aspects of the present disclosure are directed to other systems, methods, vehicles, apparatuses, tangible non-transitory computer-readable media, and devices for improving multi-modal transportation itineraries for users of a multi-modal transportation service.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 depicts a block diagram of an example computing system according to example embodiments of the present disclosure.

FIG. 2 depicts example multi-modal transportation itineraries according to example embodiments of the present disclosure.

FIG. 3 depicts an example user interface for a multi-modal transportation service according to example embodiments of the present disclosure.

FIG. 4 depicts an example user interface for a modifying a multi-modal transportation service according to example embodiments of the present disclosure.

FIG. 5 depicts an example buffer time period for an example transportation leg of a multi-modal transportation itinerary.

FIG. 6 depicts a flow diagram of a method for generating an updated candidate multi-modal transportation itinerary based on uncertainty associated with a first leg of an initial candidate multi-modal transportation itinerary according to example embodiments of the present disclosure.

FIG. 7 depicts another flow diagram of a method for generating an updated candidate multi-modal transportation itinerary based on uncertainty associated with at least one leg of an initial candidate multi-modal transportation itinerary according to example embodiments of the present disclosure.

FIG. 8 depicts another flow diagram of a method for generating an updated candidate multi-modal transportation itinerary based on uncertainty associated with at least one leg of an initial candidate multi-modal transportation itinerary according to example embodiments of the present disclosure.

### DETAILED DESCRIPTION

Example aspects of the present disclosure are directed to a multi-modal transportation service. The multi-modal transportation service can include a multi-leg transportation service that utilizes a plurality of different transportation modalities across a number of different transportation mediums such as, for example, one or more different ground-based modalities (e.g., manually driven motor vehicles, autonomously driven motor vehicles, light electric vehicles, etc.), one or more different aerial-based modalities (e.g., electric vertical take-off and landing aircraft, airplanes, drones, etc.), one or more different water-based modalities (e.g., cruise ships, ferries, etc.), and/or any other transportation modality capable of transporting people or goods. As an example, a multi-leg transportation service can include a multi-modal transportation itinerary that includes a first, second, and/or third leg each performed via the same or different transportation modality. As one example, the first and second legs can be performed via a ground-based vehicle modality (e.g., public transit) and the second leg can be performed via an aerial or water-based modality. In this example, a user associated with the multi-modal transportation itinerary can be transported from an origin location to a departing transportation node (e.g., an aerial or water transportation node) corresponding to the second leg via a first ground-based transportation service provider. The user can be transported from the departing transportation node to an arrival transportation node corresponding to the second leg via a first aerial or water-based transportation service provider. At times, the user can pool with other users of the multi-modal transportation service for the second leg of the multi-modal transportation itinerary such that multiple pooled users are transported between the departure and arrival transportation nodes. The user can be transported from the arrival node to a destination location via a second ground-based transportation service provider, thus completing a three leg multi-modal transportation service with two ground-based transportation legs and one middle aerial or water-based transportation leg.

The success of a multi-modal transportation service can depend on the timing of each of the legs. The time of each transportation leg can be disrupted by uncertainties inherent in transportation such as those caused by traffic, weather, etc. As one example, such uncertainties can cause users pooling for a middle leg of a multi-modal transportation itinerary to arrive at a departing transportation node at different times. As such, a first user arriving at the departing transportation node before a second user, with whom the first user will be pooling for the middle leg, will have to wait on the second user. This can represent a time-cost to the first user, can negatively impact the first user's experience of the multi-modal transportation service, and can result in a substantial computing cost to generate last minute contingency plans for one or more users (e.g., first user, second user) of the multi-modal transportation service. In order to successfully deploy a multi-modal transportation service, the systems and methods of the present disclosure can determine uncertainties associated with each leg of a multi-modal transportation itinerary, determine modifications for the multi-modal transportation itinerary based, at least in part, on the uncertainties, and generate an updated multi-modal transportation itinerary based, at least in part, on the modifications. In this way, multi-modal transportation itineraries can be updated to account for uncertainties ubiquitous in travel.

For instance, example aspects of the present disclosure are directed to systems and methods for determining one or more modifications to a multi-modal transportation itinerary for one or more users of the multi-modal transportation service based, at least in part, on the uncertainty associated with one or more legs (e.g., ground-leg, aerial-leg, water-leg, etc.) of the multi-modal transportation itinerary for the one or more users. In some implementations, systems and methods of the present disclosure can modify the multi-modal transportation itinerary for the one or more users to better account for the uncertainty. In this manner, an amount of time the users spend at the departing transportation node can be reduced. This reduction in time associated with switching from the from one transportation modality to another can improve the user experience, lower a total travel time, lower transportation resource waste, and increase the output for potentially finite transportation resources. Additionally, computing costs associated with generating last-minute contingency plans for one or more users of the multi-modal transportation service can be reduced or eliminated.

More particularly, a service entity can be associated with an operations computing system (e.g., a ride-sharing network system, etc.) configured to manage, coordinate, and dynamically adjust multi-modal transportation services via a ride-sharing platform. The multi-modal transportation service can include a plurality of transportation legs provided for by a service provider associated with transportation services via one or more different modalities. The one or more different modalities, for example, can include one or more different ground transportation modalities, air transportation modalities, water transportation modalities, and/or any transportation modality across any other medium (e.g., underground, space, etc.) capable of transporting a passenger or object some distance. As an example, a transportation leg provided for by a service provider associated with a ground transportation service can include transportation provided by one or more different land motor vehicles (e.g., automobiles, motorcycles, buses, etc.), one or more different light electric vehicles (e.g., electric scooters, electric bikes, etc.), one or more different rail vehicles (e.g., trains, subways, etc.), and/or any other vehicle capable of transporting a passenger or object across a ground medium (e.g., road, sidewalk, rail, land, etc.). As another example, a transportation leg provided for by a service provider associated with an air transportation service can include transportation provided by one or more different aerial vehicles such as, for example, one or more vertical take-off and landing aircraft (e.g., helicopters, VTOL, electric vertical take-off and landing aircraft (eVTOL), drones, etc.) and/or any other aircraft (e.g., gliders, jet craft, airships, balloons, hover craft, etc.) capable of transporting a passenger or object across an air medium. As yet another example, a transportation leg provided for by a service provider associated with a water transportation service can include transportation provided by one or more different watercraft such as, for example, passenger ships, ferries, catamarans, and/or any other watercraft capable of transporting a passenger or object across a water medium.

The service entity can facilitate a multi-modal transportation service for a plurality of users of the ride-sharing platform in response to a request from at least one of the plurality of users. For example, the operations computing system can obtain a request for a transportation service. The operations computing system can obtain the request from a user device associated with a user of the ride-sharing platform. The request can be generated by the user via a user interface of a software application associated with the service entity.

The request for the transportation service can include an origin location and a destination location. In some instances, unless specified otherwise, the origin of the transportation service can be assumed to be a current location of the user (e.g., as indicated by location data such as GPS data received from the user device and/or as input by the user). A user can also supply a desired destination (e.g., by typing the destination into a text field which may, for example, provide suggested completed entries while the user types). A multi-modal transportation itinerary from the origin location to the destination location can be generated based on the request for the transportation service.

To help facilitate a multi-modal transportation service for the user that accounts for uncertainties associated with the multi-modal transportation service, the operations computing system can be configured to obtain an initial candidate multi-modal transportation itinerary for the user. The initial candidate multi-modal transportation itinerary can include at least a first transportation leg and a second transportation leg. The first transportation leg can include a first transportation modality and the second transportation leg can include a second transportation modality. For example, the first transportation leg can be performed via a first transportation modality (e.g., transportation provided by a transportation service provider associated with the first transportation modality) and the second transportation leg can be performed via the second transportation modality (e.g., a transportation provided by a transportation service provider associated with the second transportation modality). The first transportation modality can be different from the second transportation modality.

For example, the first transportation leg can be associated with transporting the user from the origin location to a departing transportation node corresponding to the second transportation leg. The second transportation leg can be associated with transporting the user from the departing transportation node to an arrival transportation node. The nodes can be associated with the second transportation modality. For instance, the second transportation modality can include an aerial-based transportation modality. In such a case, the nodes can include aerial transportation facilities (e.g., airports, vertiports, etc.) associated with the aerial transportation modality. As another example, the second transportation modality can include a water-based transportation modality. In such a case, the nodes can include water side facilities (e.g., harbors, docks, marinas, etc.) associated with the water-based transportation modality.

As further described herein, the initial candidate multi-modal transportation itinerary can, in some implementations, include more than two transportation legs such as, for example, a third transportation leg. The third transportation leg can include a third transportation modality different from the second transportation modality. For example, the third transportation leg can be performed via a third transportation modality (e.g., transportation provided by a transportation service provider associated with the third transportation modality). In one example, the initial candidate multi-modal transportation itinerary can include a first, ground transportation, leg, a second, aerial transportation, leg, and a third, ground transportation, leg. The first, ground transportation, leg can include a first ground-based transportation service from the origin location to the departing transportation node, the second, aerial transportation, leg can include a first aerial-based transportation service from the departing transportation node to the arrival transportation node, and the third, ground transportation, leg can include a second ground-based transportation service associated with transporting the user from the arrival transportation node to a destination location (e.g., requested by the user, etc.).

The operations computing system can be configured to determine an uncertainty with one or more of the transportation legs of the initial candidate multi-modal transportation itinerary. For instance, the operations computing system can be configured to determine an uncertainty associated with the first leg of the initial candidate multi-modal transportation itinerary. The uncertainty for a transportation leg can be expressed as a value (e.g., a value on a 1-10 scale, etc.), a percentage, a relative level (e.g., low, medium, high, etc.), a decimal, a confidence level, a time range, and/or in any other manners. In some implementations, the uncertainty can be associated with an estimated time-of-arrival of the user at a location along the multi-modal transportation itinerary such as, for example, the departing transportation node corresponding to the second transportation leg.

The operations computing system can be configured to determine the uncertainty based, at least in part, on data indicative of one or more sources of uncertainty associated with the first, second, or third transportation legs. For example, uncertainty for a transportation leg can be determined based, at least in part, on multi-modal transportation data. For instance, the operations computing system can obtain the multi-modal transportation data associated with the multi-modal transportation service. The multi-modal transportation data can include historical data and/or information received from one or more transportation service providers.

The multi-modal transportation data can include data associated with one or more candidate multi-modal transportation itineraries for the user. For example, the multi-modal transportation data can be indicative of a time of departure for each transportation leg (e.g., a first, second, third, etc.) of the one or more candidate multi-modal transportation itineraries. In addition, or alternatively, the multi-modal transportation data can include a transportation modality for each of the transportation legs. In some implementations, the multi-modal transportation data can include historical data indicative of one or more events associated with at least one of the time of departure(s), the departing/arrival transportation node(s), geographic region(s) corresponding to the origin/destination locations and/or the transportation node(s), or the transportation modalities for each of the transportation legs. The computing system can determine an uncertainty associated with an estimated time-of-arrival of the user at the departing transportation node based, at least in part, on the multi-modal transportation data. For example, the uncertainty associated with the estimated time-of-arrival of the user at the departing transportation node corresponding to the second leg can be determined based, at least in part, on the historical data.

More particularly, a transportation modality (e.g., and/or the historical data thereof) for a transportation leg can be a source of uncertainty. For example, the reliability of an estimated time-of-arrival can vary depending on a transportation modality. By way of example, a ground-based transportation modality can involve more uncertainty (e.g., due to traffic, and other land based factors) than aerial and/or water-based transportation modalities. In some implementations, the uncertainty for a first transportation leg can be determined based, at least in part, on at least one of the first transportation modality of the first transportation leg and/or the second transportation modality of the second transportation leg.

In addition, or alternatively, geographical regions (and/or historical data thereof) associated with the origin location, departure/arrival nodes, and/or destination locations can be a source of uncertainty. By way of example, different locations can involve more uncertainty (e.g., due to traffic, and other regional based factors).

For example, traffic and/or weather (and/or historical data thereof) can be a source of uncertainty. By way of example, autonomous and/or human-operated ground motor vehicles can encounter traffic conditions that can be a source of uncertainty. In this regard, time-of-day (e.g., rush-hour) and weather (e.g., rain, snow, etc.) can affect traffic conditions. As another example, aerial and/or water-based transportation modalities encounter weather conditions that can be a source of uncertainty. The uncertainty associated with weather and/or traffic conditions can introduce uncertainty associated with an estimated time-of-arrival of vehicles at the origin location, departure/arrival nodes, and/or destination locations.

In some implementations, a user (and/or historical data thereof) associated with a transportation leg can be a source of uncertainty. For instance, the user may not be ready to board a vehicle when the vehicle arrives at the origin/destination location(s) and/or the departure/arrival transportation node(s). In some instances, the ground-based transportation service may be cancelled if the user fails to board the autonomous or human-operated vehicle within a predetermined amount of time (e.g., 2 minutes) after the autonomous or human-operated vehicle arrives at the origin location. In such instances, another autonomous or human-operated vehicle may be deployed to pick up the user at the origin location.

In some implementations, a type of vehicle selected for the ground-based transportation service (e.g., autonomous, manual, etc.) can be a source of uncertainty associated with a first leg of the initial candidate multi-modal transportation itinerary. For instance, historical data associated with a first type of autonomous vehicle may be better compared to historical data associated with a second type of autonomous vehicle. More specifically, the historical data can indicate that the first type of autonomous vehicle is better than the second type of autonomous vehicle at delivering a user to a drop-off location (e.g., departing transportation node) by an estimated time-of-arrival.

In some implementations, a rating associated with an operator (e.g., driver, captain, pilot, etc.) of a human-operated vehicle can be a source of uncertainty. For instance, historical data associated with the operator can be indicative of performance of the operator at delivering a user to a drop-off location by an estimated time-of-arrival (e.g., a lower uncertainty can be associated with operators that historically drop-off users within a window of the estimated time-of-arrival, etc.). Alternatively, or additionally, the historical data can indicate whether the operator has completed a route associated with a transportation leg (e.g., a lower uncertainty can be associated with drivers that are familiar with the route, a higher uncertainty can be associated with drivers that may not be familiar with the route, etc.).

In some implementations, the origin location can be a source of uncertainty. For instance, historical data can indicate that users picked up at the origin location arrive at the departing transportation node earlier than an estimated time-of-arrival. Alternatively, historical data can indicate that users picked up at the origin location arrive at the departing transportation node later than the estimated time-of-arrival.

The operations computing system can be configured to determine one or more modifications to the initial candidate multi-modal transportation itinerary based, at least in part, on the uncertainty associated with the first leg of the initial candidate multi-modal transportation itinerary. In some implementations, the one or more modifications can include switching a transportation modality of the ground-based vehicle service for the first leg from a first type of transportation modality (e.g., autonomous vehicle or human-operated vehicle) to a second type of transportation modality (e.g., bicycle, scooter, etc.) that is different than the first type of transportation modality. The second type of transportation modality (e.g., walking, bicycle, etc.) can lower the uncertainty associated with the first leg, because the second type of transportation modality can, for example, help avoid certain sources of uncertainty (e.g., high automobile traffic, a would-be assigned driver, etc.).

Alternatively, or additionally, the one or more modifications can include switching the departing transportation node from a first transportation node to a second transportation node that is closer to the origin location. A vehicle associated with a second leg of the multi-modal transportation itinerary can be assigned and/or updated based on the second transportation node (e.g., that is closer to the user, etc.). This may occur despite the fact it may lengthen the distance of the second transportation leg for the user.

The computing system can be configured to generate an updated candidate multi-modal transportation itinerary for the user based, at least in part, on the one or more modifications to the initial candidate multi-modal transportation itinerary. In some implementations, the first leg of the updated candidate multi-modal transportation itinerary can be different than the first leg of the initial candidate multi-modal transportation itinerary. For instance, the type of transportation modality of the ground-based transportation service for the first leg of the updated candidate multi-modal transportation itinerary can be different than the type of transportation modality of the ground-based transportation service for the first leg of the initial candidate multi-modal transportation itinerary.

Alternatively, or additionally, the departing transportation node associated with the updated candidate multi-modal transportation itinerary can be different than the departing transportation node for the second leg of the initial candidate multi-modal transportation itinerary. For example, the departing transportation node associated with the updated candidate multi-modal transportation itinerary can be closer to the origin location than the departing transportation node associated with the initial candidate multi-modal transportation itinerary, as described herein.

The computing system can be configured to communicate the updated candidate multi-modal transportation itinerary to a user device (e.g., smartphone, tablet, etc.) associated with the user. For instance, in some implementations, the updated candidate multi-modal transportation itinerary can be displayed via a user interface of the user device (e.g., associated with the software application via which the transportation request was initiated). In this manner, the user can view the updated candidate multi-modal transportation itinerary. The user interface can present the updated candidate multi-modal transportation itinerary with only a transportation modality option for the first leg that reduces the uncertainty associated with the first leg, as described herein.

In some implementations, the updated candidate multi-modal transportation can include both the first type of transportation modality and the second type of transportation modality for the ground-based transportation service associated with the first leg. For instance, the second type of transportation modality can be prioritized over the first type of transportation modality due, at least in part, to the uncertainty associated with the first leg being lower with the second type of transportation modality. For example, the second type of transportation modality can be presented above (and/or more prominently) than the first type of transportation modality. Furthermore, in some implementations, the user interface can display one or more incentives (e.g., reward points, discounted price, etc.) to encourage the user to select the second type of transportation modality over the first type of transportation modality. The user can select the updated candidate multi-modal transportation itinerary via the user interface (e.g., via a touch-based user input, etc.). As a result, the multi-modal transportation service can be booked for the user to travel from an origin location to a destination location.

Example aspects of the present disclosure are also directed to systems and methods for modifying a multi-modal transportation itinerary for a user of a multi-modal transportation service. The multi-modal transportation itinerary for the user can be, for example, a candidate multi-modal transportation itinerary (e.g., an updated candidate itinerary) selected by the user (e.g., via the user interface of the service entity's software application). The multi-modal transportation service can include a first leg and a second leg. The first leg can include a ground-based transportation service associated with transporting the user from an origin location to a departing transportation node. The second leg can include an aerial-based transportation service, a water-based transportation service, etc. associated with transporting the user from the departing transportation node to a destination transportation node.

In some implementations, the computing system can determine the uncertainty associated with the estimated time-of-arrival based, at least in part, on a time difference between the estimated time-of-arrival of the user at the departing transportation node corresponding to the second leg and the departure time of a transportation service associated with the departing transportation node, as described herein.

For example, at times, the transportation service at the departing transportation node can include a transportation schedule. For instance, the second transportation modality can be associated with the transportation schedule. The transportation schedule, for example, can include a plurality of scheduled departure, maintenance, and/or arrival times for a plurality of assets of the second transportation modality. By way of example, in the event that the second transportation modality is an aerial-based transportation modality, the transportation schedule can include a flight schedule descriptive of a plurality of take-off times/locations, landing times/locations, boarding times/locations, maintenance times/locations, etc. for each of a plurality of assets of one or more aerial transportation service providers. As another example, in the event that the second transportation modality is a water-based transportation modality, the transportation schedule can include a schedule descriptive of a plurality of departure times/locations, arrival times/locations, boarding times/locations, maintenance times/locations, etc. for each of a plurality of assets of one or more water transportation service providers.

In some implementations, the operations computing system can be configured to classify the uncertainty associated with the estimated time-of-arrival of the user at the departing transportation node based, at least in part, on the time difference. For instance, the operations computing system can be configured to determine uncertainty associated with the estimated time-of-arrival of the user at the departing transportation node is low (e.g., less than about 25 percent) when the time difference is smaller than a threshold value (e.g., about 5 minutes). Alternatively, the operations computing system can be configured to determine uncertainty associated with the estimated time-of-arrival of the user at the departing transportation node is high (e.g., greater than 50 percent) when the time difference is larger than the threshold value.

The operations computing system can determine one or more modifications to the multi-modal transportation itinerary based, at least in part, on the uncertainty associated with the estimated time-of-arrival. For instance, when the computing system determines the uncertainty associated with the estimated time-of-arrival of the user at the departing transportation node is high (e.g., greater than about 50 percent, greater than about 60 percent, greater than about 70 percent, etc.), the one or more modifications to the multi-modal transportation itinerary can include moving the user to a service with a later departure time. In this manner, other users pooling with the user at the departing transportation node will not be inconvenienced due to the high uncertainty associated with the estimated time-of-arrival of the user at the departing transportation node. Alternatively, when the operations computing system determines the uncertainty associated with the estimated time-of-arrival of the user at the departing transportation node is low (e.g., less than about 30 percent, less than about 20 percent, etc.), the one or more modifications determined by the operations computing system can include delaying (e.g., holding) the departure time of the transportation service for the user.

In some implementations, the one or more modifications to the multi-modal transportation itinerary can be based, at least in part, on whether one or more users with whom the user will be pooling with for the second leg of the multi-modal transportation itinerary have already arrived at the departing transportation node. For instance, when the uncertainty associated with the estimated time-of-arrival of the user at the departing transportation node is low and one or more users pooling with the user for the second leg have already arrived at the departing transportation node (and have been or are predicted to wait over a threshold amount of time), the one or more modifications can include booking the user on a service with a later departure time. In this manner, the one or more users already at the departing transportation node will not be inconvenienced by having to wait over the threshold amount of time (e.g., about 8 minutes). As used herein, use of the term “about” refers to range of numerical values within 25 percent of the stated numerical value.

The computing system can be configured to communicate one or more command signals associated with updating the multi-modal transportation itinerary according to the one or more modifications. In some implementations, the one or more command signals can be associated with generating an updated multi-modal transportation itinerary for the user. For example, when the user is being moved to a later flight to accommodate the high uncertainty associated with the estimated time-of-arrival of the user at the departing transportation node, the updated multi-modal transportation itinerary can include information associated with the later flight. As another example, when the flight is being delayed to accommodate the user, the one or more command signals can be associated with providing one or more notifications indicative of the new departure time to the user and one or more other users with whom the user will be pooling for the second leg of the multi-modal transportation itinerary.

Example aspects of the present disclosure are also directed to generating candidate multi-modal transportation itineraries for a user of a multi-modal transportation service based on uncertainties associated with any leg (e.g., first leg, second leg, third leg) of the multi-modal transportation itinerary. For example, as described herein, a computing system (e.g., operations computing system, etc.) can obtain an initial candidate multi-modal transportation itinerary for the user. The initial candidate multi-modal transportation itinerary can include a first leg, a second leg, and a third leg. The first leg can include a first ground-based transportation service associated with transporting the user from an origin location to a departing transportation node. The second leg can include an aerial-based transportation service associated with transporting the user from the departing transportation node to a destination transportation node. The third leg can include a second ground-based transportation service associated with transporting the user from the destination airport facility to a destination location. For instance, in some implementations, the destination location can be an airport at which the user is scheduled to board a flight (e.g., commercial flight, private jet, etc.).

The computing system can determine an uncertainty associated with at least one leg of the initial candidate multi-modal transportation itinerary. For instance, in some implementations, the computing system can determine an uncertainty associated with the first leg of the initial candidate multi-modal transportation itinerary. Alternatively, or additionally, the computing system can determine an uncertainty associated with the third leg of the initial candidate multi-modal transportation itinerary. The computing system can determine the uncertainty associated with the third leg of the initial candidate multi-modal transportation itinerary in manners similar to those described herein for the first leg. For example, the computing system can determine an uncertainty associated with an autonomous and/or human-operator based at least in part on the autonomous vehicle's/driver's familiarity with a route to the destination transportation node, the autonomous vehicle's/driver's history of picking-up and/or dropping-off a user on time, traffic condition(s), weather, etc.

The computing system can determine one or more modifications to the initial candidate multi-modal transportation itinerary for the user based, at least in part, on the uncertainty associated with at least one leg of the initial candidate multi-modal transportation itinerary. In some implementations, the one or more modifications can include adjusting a type of transportation modality of the first ground-based transportation service of the first leg, the second ground-based transportation service of the third leg, or both. For instance, the type of transportation modality of the first ground-based transportation service (of the first leg), the second ground-based transportation service (of the third leg), or both can be adjusted to avoid a violation of an estimated time-of-arrival of the user at the destination location (e.g., airport). This modification(s) can be made to reduce the uncertainty associated with one or more legs of the initial candidate multi-modal transportation itinerary.

The computing system can generate an updated candidate multi-modal transportation itinerary for the user based at least in part on the one or more modifications to the initial candidate multi-modal transportation itinerary (e.g., to include the modified first and/or third transportation leg to reduce uncertainty, etc.). Furthermore, the computing system can communicate data associated with the updated candidate multi-modal transportation itinerary to a user device (e.g., smartphone, tablet, etc.) associated with the user. For instance, in some implementations, the updated candidate multi-modal transportation itinerary can be displayed on a user interface running on the user device. In this manner, the user can view the updated candidate multi-modal transportation itinerary. The user can select the updated candidate multi-modal transportation itinerary via the user interface (e.g., via a touch-based user input, etc.).

Example aspects of the present disclosure can provide a number of improvements to computing technology. For instance, a computing system of the present disclosure can modify a multi-modal transportation itinerary for one or more users of the multi-modal transportation service based, at least in part, on the uncertainty associated with the first leg (e.g., ground leg) and/or another leg of the multi-modal transportation itinerary for the one or more users. More specifically, the computing system can modify the multi-modal transportation itinerary to reduce the uncertainty within the itinerary. Computing resources (e.g., processing, memory, communication, power, etc.) associated with generating last-minute contingency plans for one or more users of the multi-modal transportation service can be saved/reduced. This can also result in a reduction in time associated with switching from the ground-based transportation service to the aerial-based transportation service at the departing transportation node, thereby improving the user experience.

The computing system of the present disclosure can, in some implementations, be configured to adjust a type of transportation modality of a ground-based transportation service of the first leg to reduce or eliminate uncertainty associated with the estimated time-of-arrival of the user at the departing transportation node. For instance, the computing system can adjust the transportation modality of the transportation service from a first type (e.g., autonomous or human-operated vehicle) to a second type (e.g., bicycle, scooter, etc.). Alternatively, or additionally, the computing system can adjust the type of transportation of a ground-based transportation service associated with a third leg of the multi-modal transportation service to reduce or eliminate uncertainty associated with the estimated time-of-arrival of the user at a destination location (e.g., airport). In this manner, the computing system of the present disclosure can generate a multi-modal transportation itinerary for a user to reduce or eliminate uncertainty associated with an estimated time-of-arrival of the user at one or more locations (e.g., departing transportation node, destination location, etc.).

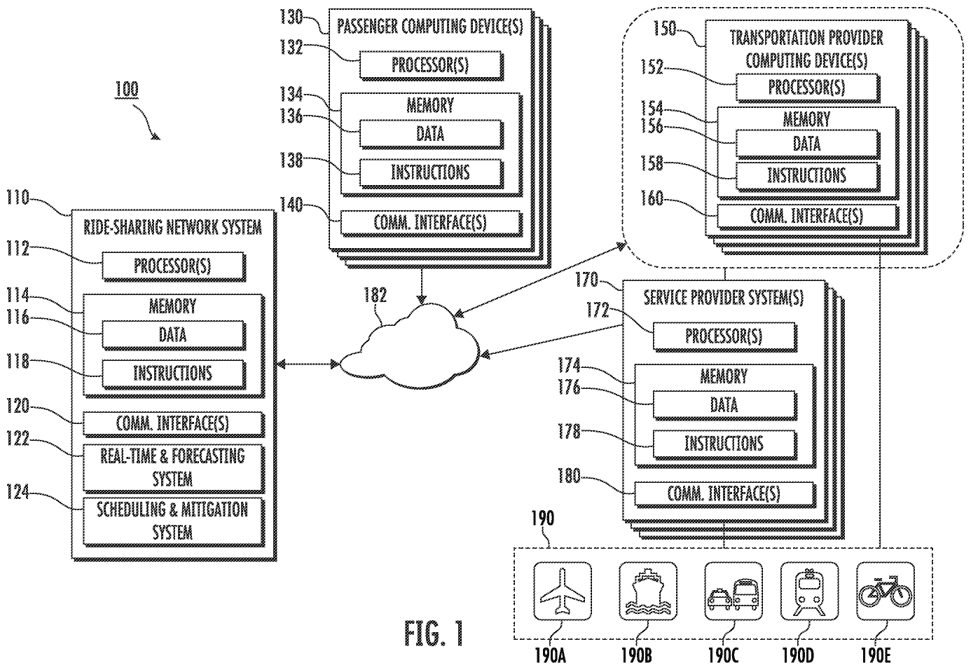

Referring now to the FIGS. 1-7, FIG. 1 depicts a block diagram of an example computing system 100 according to example embodiments of the present disclosure. The computing system 100 can include a ride-sharing network system 110 configured to manage, coordinate, and dynamically adjust multi-modal transportation services via a ride-sharing platform. The multi-modal transportation service can include a plurality of transportation legs provided for by a service provider system(s) 170 associated with transportation services via one or more different modalities 190. The one or more different modalities, for example, can include one or more different air transportation modalities 190A, water transportation modalities 190B, ground transportation modalities 190C, 190D, 190E, and/or any transportation modality across any other medium (e.g., underground, space, etc.) capable of transporting a passenger or object some distance. By way of example, the ground transportation modalities can include one or more roadway vehicle modalities 190C, railway modalities 190D, and/or pedestrian modalities 190E (e.g., walking, biking, scootering, skateboarding, etc.).

The ride-sharing network system 110 can be communicatively connected over a network 182 to one or more passenger computing devices 130, one or more transportation provider computing devices 150 corresponding with vehicle of one or more of the transportation modalities 190. The one or more transportation provider computing devices 150, for example, can include one or more vehicle computing devices and/or operator computing devices for a vehicle associated with the one or more transportation modalities 190.

The ride-sharing network system 110, the passenger computing device(s) 130, the transportation service provider computing device(s) 150, and the service provider system(s) 170 can each respectively include one or more processors 112, 132, 152, 172 and memories 114, 134, 154, 174. The one or more processors 112, 132, 152, 172 for each respective system/device 110, 130, 150, 170 can be any suitable processing device (e.g., a processor core, a microprocessor, an ASIC, a FPGA, a controller, a microcontroller, etc.) and can be one processor or a plurality of processors that are operatively connected. The memory 114, 134, 154, 174 for each respective system/device 110, 130, 150, 170 can include one or more non-transitory computer-readable storage media, such as RAM, ROM, EEPROM, EPROM, one or more memory devices, flash memory devices, etc., and combinations thereof.

The memory 114, 134, 154, 174 can store information that can be accessed by the one or more processors 112, 132, 152, 172. For instance, the memory 114, 134, 154, 174 (e.g., one or more non-transitory computer-readable storage mediums, memory devices) can store data 116, 136, 156, 176 that can be obtained, received, accessed, written, manipulated, created, and/or stored. In some implementations, the system/devices 110, 130, 150, 170 can obtain data from one or more memory device(s) that are remote from the respective systems/devices 110, 130, 150, 170.

The memory 114, 134, 154, 174 can also store computer-readable instructions 118, 138, 158, 178 that can be executed by the one or more processors 112, 132, 152, 172. The computer-readable instructions 118, 138, 158, 178 can be software written in any suitable programming language or can be implemented in hardware. Additionally, or alternatively, the computer-readable instructions 118, 138, 158, 178 can be executed in logically and/or virtually separate threads on the one or more processors 112, 132, 152, 172. For example, the memory 114, 134, 154, 174 can store the computer-readable instructions 118, 138, 158, 178 that, when executed by the one or more processors 112, 132, 152, 172, cause the one or more processors 112, 132, 152, 172 to perform any of the operations and/or functions described herein.

The ride-sharing network system 110 can include a number of different systems for generating and/or modifying multi-modal transportation services. For instance, the ride-sharing network system 110 can include a real-time/forecasting system 122 and a scheduling/mitigation system 124. Each of the systems 122, 124 can be implemented in software, firmware, and/or hardware, including, for example, as software which, when executed by the processors 112 cause the ride-sharing network system 110 to perform desired operations. The systems 122, 124 can cooperatively interoperate (e.g., including supplying information to each other).

The real-time & forecasting system 122 can operate to maintain data descriptive of a current state of the world. For example, the real-time & forecasting system 122 can generate, collect, and/or maintain data descriptive of predicted passenger demand; predicted service provider supply; predicted weather conditions; planned itineraries; pre-determined transportation plans (e.g., flight plans) and assignments; current requests; current ground transportation service providers; current transportation node operational statuses (e.g., including re-charging or re-fueling capabilities); current vehicle statuses (e.g., including current fuel or battery level); current vehicle operator (e.g., driver, pilots, captains, etc.) statuses; current vehicle movement states and trajectories; current airspace information; current communication system behavior/protocols; and/or the like. The real-time & forecasting system 122 can obtain such world state information through communication with some or all of the computing devices 130, 150 and/or system 170.

For example, passenger computing devices 130 can provide current information about passengers. Passenger computing devices 130, for instance, can include one or more user devices (e.g., smartphone, tablet, etc.) associated with a passenger of one or more service providers system(s) 170. The passenger computing devices 130 can monitor the progress of a respective passenger and provide current information about the passenger to the real-time & forecasting system 122. Computing devices 130, 150, and 170 can provide current information about service providers and/or vehicles utilized by service providers. More particularly, the transportation provider computing devices 150 can be associated with a vehicle (and/or an intermediary computing system 170) of a respective transportation modality 190. For example, the transportation provider computing devices 150 can include a vehicle computing device, a system of an autonomous, semi-autonomous, or non-autonomous vehicle, or an intermediary computing system for a public transportation service. As another example, the transportation provider computing devices 150 can include an operator device associated with an operator (e.g., driver, pilot, remote operator, captain, conductor, etc.) of a vehicle.

The real-time & forecasting system 122 can generate predictions of the demand and supply for transportation services at or between various locations over time. The real-time & forecasting system 122 can also generate or supply weather forecasts. The forecasts made by the system 122 can be generated based on historical data and/or through modeling of supply and demand. The real-time & forecasting system 122 system can be able to simulate the behavior of a full day of activity across multiple ride share networks.

The scheduling & mitigation system 124 can generate transportation plans for various transportation assets and/or can generate itineraries for passengers. For example, the scheduling & mitigation system 124 can perform flight planning, water way route planning, pedestrian walkway planning, etc. As another example, the scheduling & mitigation system 124 can plan or manage/optimize itineraries which include interactions between passengers and service providers across multiple modes of transportation.

In some implementations, the scheduling & mitigation system 124 can include an uncertainty calculation component that can obtain multi-modal transportation data for a multi-modal transportation service from one or more systems (e.g., real-time & forecasting system 122, scheduling & mitigation system 124, service provider system(s) 170). For instance, the multi-modal transportation data obtained from the scheduling & mitigation system 124 can include a multi-modal transportation itinerary for a user of the multi-modal transportation service. The multi-modal transportation data obtained from the real-time & forecasting system 122 can include data associated with weather conditions and/or traffic conditions affecting the multi-modal transportation service. The uncertainty calculation component can be configured to determine an uncertainty of one or more transportation legs (e.g., ground-leg, aerial-leg, water-leg, etc.) of the multi-modal transportation itinerary based, at least in part, on the multi-modal transportation data (e.g., traffic conditions, weather conditions, time of day, transportation modality, etc.), as further described herein.

The scheduling & mitigation system 124 can match a passenger with a service provider 170 for each of the different transportation modalities 190. For example, the scheduling & mitigation system 124 can communicate with the corresponding transportation provider computing devices 150 and/or a service provider system 170 associated with a plurality of transportation provider computing device(s) of a respective transportation modality 190 via one or more APIs or connections. The scheduling & mitigation system 124 can communicate trajectories and/or assignments to the corresponding service providers (e.g., via the service provider system(s) 170 and/or directly to the transportation provider computing device(s) 150). Thus, the scheduling & mitigation system 124 can perform or handle assignment of ground transportation, flight trajectories, water trajectories, pedestrian direction, take-off/landing activities, etc.

For example, the one or more transportation service provider device(s) 150 of a respective service provider system 170 can be associated with a vehicle (e.g., an aircraft, watercraft, spacecraft, public transportation vehicle, etc.). The transportation service provider device(s) 150 can include, for instance, a user computing device associated with an operator (e.g., a pilot, captain, conductor, etc.) of a vehicle (e.g., an aircraft, watercraft, spacecraft, public transportation vehicle, etc.), a vehicle computing device associated with the vehicle, etc. For instance, the vehicle can include an autonomous vehicle with a vehicle computing system (e.g., transportation service provider device(s) 150) configured to facilitate the autonomous movement of the vehicle.

The scheduling & mitigation system 124 can perform monitoring of user itineraries and can perform mitigation when an itinerary is subject to significant delay (e.g., one of the legs fails to succeed). Thus, the scheduling & mitigation system 124 can perform situation awareness, advisories, adjustments, and the like. The scheduling & mitigation system 124 can trigger alerts and actions sent to the computing devices 130, 150, and 170. For example, passengers, service providers, vehicles, and/or operations personnel can be alerted when a certain transportation plan has been modified and can be provided with an updated plan/course of action. Thus, the scheduling & mitigation system 124 can have additional control over the movement of vehicles and vehicle operators of various transportation modalities 190 and passengers transported by the respective vehicles.

In some implementations, the ride-sharing network system 110 can store or include one or more machine-learned models. For example, the models can be or can otherwise include various machine-learned models such as support vector machines, neural networks (e.g., deep neural networks), decision-tree based models (e.g., random forests), or other multi-layer non-linear models. Example neural networks include feed-forward neural networks, recurrent neural networks (e.g., long short-term memory recurrent neural networks), convolutional neural networks, or other forms of neural networks.

In some implementations, the transportation provider computing devices 150 can be associated with autonomous vehicles (e.g., autonomous aircraft such as vertical take-off and landing aircraft, autonomous trucks, autonomous ships, autonomous public transportation vehicles such as subways, trains, etc.). Thus, the transportation provider computing devices 150 can provide communication between the ride-sharing network system 110 and an autonomy stack of the autonomous vehicle which autonomously controls motion of the autonomous vehicles.

The one or more networks 182 can be any type of network or combination of networks that allows for communication between devices. In some embodiments, the network(s) can include one or more of a local area network, wide area network, the Internet, secure network, cellular network, mesh network, peer-to-peer communication link and/or some combination thereof and can include any number of wired or wireless links. Communication over the one or more networks 182 can be accomplished, for instance, via a network interface using any type of protocol, protection scheme, encoding, format, packaging, etc.

For example, the ride-sharing network system 110 can be configured to manage, coordinate, and dynamically adjust a multi-modal transportation service via a transportation platform. The multi-modal transportation service can include a plurality of transportation legs, one of which (e.g., a second transportation leg) can include a transport of a user through one or more transportation modalities such as air modality, water modality, etc. that are different from a ground transportation vehicle. For example, the ride-sharing network system 110 can obtain a request for a transportation service (e.g., from a passenger computing device 130). The request for the transportation service can include at least a request for an aerial transport, water transport, public transport, etc. of a user of the transportation platform. The ride-sharing network system 110 can obtain the request from a user device (e.g., a passenger computing device 130) associated with the user of the transportation platform.

The request for the transportation service can include an origin location and a destination location. In some instances, unless specified otherwise, the origin of the transportation service can be assumed to be a current location of the user (e.g., as indicated by location data such as GPS data received from a passenger computing device 130 and/or as input by the user). A user can also supply a desired destination (e.g., by typing the destination into a text field which may, for example, provide suggested completed entries while the user types).

A multi-modal transportation itinerary from the origin location to the destination location can be generated based on the request for the transportation service. The multi-modal transportation itinerary can include two or more transportation legs (e.g., a first transportation leg, a second transportation leg, a third transportation leg, etc.) between the origin location and the destination location specified in the request. The two or more transportation legs can include travel via two or more different transportation modalities such as, for example: cars, motorcycles, light electric vehicles (e.g., electric bicycles or scooters), buses, trains, aircraft (e.g., airplanes, vertical take-off and landing vehicles, etc.), watercraft, walking, and/or other transportation modalities across different transportation mediums. Example vehicle modalities across an air medium can include airplanes, helicopters, and/or other vertical take-off and landing aircraft (VTOL) such as electric vertical take-off and landing aircraft (eVTOL). Example vehicle modalities across a ground medium can include automobiles, scooters, public transportation vehicles (e.g., subways, trains, buses, etc.). Example vehicle modalities across a water medium can include ferries, ships, etc. The vehicles can include non-autonomous, semi-autonomous, and/or fully-autonomous vehicles.

The ride-sharing network system 110 can facilitate the ability of a user to receive transportation on one or more of the transportation legs included in the multi-modal transportation itinerary. As an example, the ride-sharing network system 110 can interact with a plurality of devices (e.g., one or more transportation provider computing devices 150, one or more service provider system(s) 170, etc.) to match the user with one or more transportation service providers for each transportation leg of the multi-modal transportation itinerary. For example, the ride-sharing network system 110 can book or otherwise reserve a seat in, space on, or usage of one or more of the transportation modalities for the user. For example, the request for a transportation service can include a request for transportation of the user through multiple transportation modalities 190. In response, the ride-sharing network system 110 can determine a transportation service provider computing device 150 (and/or service provider system 170) to provide the transportation to the user (e.g., book a seat on a vehicle of the service provider system 170 or the transportation provider computing device 150) for each of the multiple transportation modalities 190.

For example, in response to a user's request, the ride-sharing network system 110 can utilize the one or more algorithms/machine-learned models to generate a multi-modal transportation itinerary for the user. As an example, in some implementations, the ride-sharing network system 110 can sequentially analyze and identify potential transportation legs for each different available transportation modality 190. For example, a most critical, challenging, and/or supply-constrained transportation leg can be identified first and then the remainder of the multi-modal transportation itinerary can be stitched around such leg. In some implementations, the order of analysis for the different modalities can be a function of a total distance associated with the transportation service (e.g., shorter transportation services result in ground-based modalities 190C-E being assessed first while longer transportation services result in flight-based modalities 190A, water-based modalities 190B, etc. being assessed first). By way of example, the ride-sharing network system 110 can assign the user to an aircraft, watercraft, spacecraft, etc. for the middle leg of a three-leg multi-modal itinerary and then, book a human-driven or autonomous ground-based vehicle 190C for a first leg of the multi-modal itinerary to take the user(s) from an origin location to a first transportation node (e.g., to board the aircraft, watercraft, spacecraft, etc. such as, for example, at an origin facility). At a later time (e.g., while the user(s) are in en route to a destination facility), the ride-sharing network system 110 can book another human-driven or autonomous ground-based vehicle 190C to take the user(s) from a second transportation node (e.g., a destination facility) to the specified destination location(s).

In some implementations, the intermediary transportation leg can be booked based at least in part on data obtained via a third-party service provider system 170. For instance, to determine what vehicle and/or trips are available for a multi-modal transportation service, the ride-sharing network system 110 can communicate with a service provider system 170 associated with (e.g., that operates, owns, controls, leases, etc.) a particular modality of the plurality of modalities 190. The ride-sharing network system 110 can obtain data indicative of candidate trips/vehicles (and/or transportation provider computing device(s) thereof) available for the multi-modal service from the service provider system 170. This can include, for example, a flight schedule, a water-way route schedule, etc. generated by the third-party service provider.

In this manner, the ride-sharing network system 110 can generate a multi-modal transportation itinerary for facilitating the alternative modality transportation of the multi-modal transportation service. The multi-modal transportation itinerary can include at least a first transportation leg, a second transportation leg, and a third transportation leg. A service provider of a modality other than the ground-based automobile mobility 190C, for example, can be associated with the second transportation leg to provide the alternative transportation to the user during the second transportation leg from a first transportation node to a second transportation node.

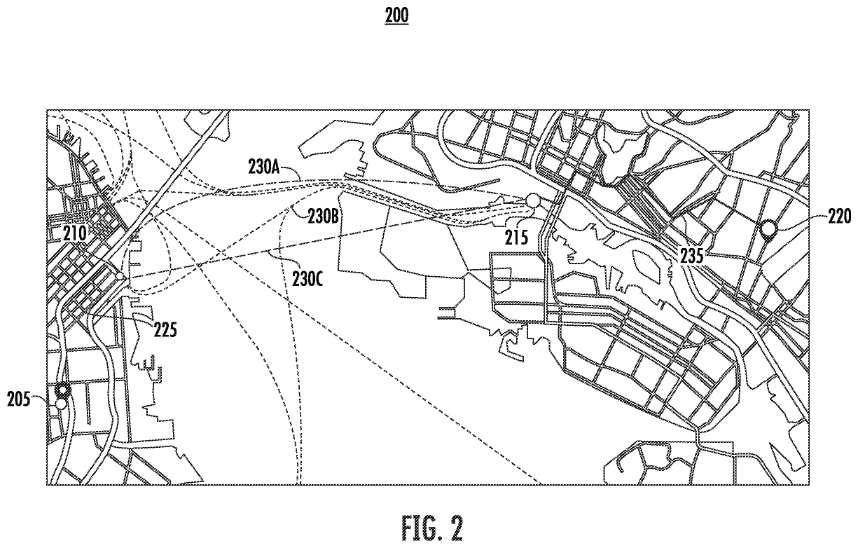

Referring now to FIG. 2, a multi-modal transportation service 300 is depicted according to example embodiments of the present disclosure. As shown, the multi-modal transportation service 200 can include a first ground-based transportation service 225 associated with transporting one or more users from an origin location 205 (e.g., house, office, etc.) to a departing transportation node 210. In some implementations, to the extent a plurality of users are included in the first transportation leg, it should be understood that the origin location 205 may be different for each of the users. For instance, the origin location 205 for a first user may be an office building, whereas the origin location 205 for a second user may be an apartment complex. The first ground-based transportation service 225 can include at least a first type of transportation modality (e.g., autonomous or human-operated vehicle) or a second type of transportation modality (e.g., walking, bicycle, scooter, etc.) that is different than the first type of transportation modality.

The multi-modal transportation service 200 can include an intermediate leg 230 that includes transportation through one or more alternative transportation modalities. For example, a first intermediate leg 230A can include an aerial-based transportation service associated with transporting the user(s) from the departing aerial transportation node 210 to a destination aerial transportation node 215. The aerial-based transportation service can also include users (associated with other itineraries) that have arrived at the departing aerial transportation node 210 via one or more other vehicles and/or other modalities (e.g., walking, bike, scooter, etc.). The aerial-based transportation service 230A can include an aerial vehicle configured to land on a rooftop (and/or upper level) of the departing transportation node 210. In this manner, user(s) can board the aerial vehicle. When the users are onboard the aerial vehicle, the aerial vehicle can takeoff and fly to the destination aerial transportation node 215. More specifically, the aerial vehicle can land on a rooftop (and/or upper level) of the destination aerial transportation node 215. In this manner, the user(s) can deboard the aerial vehicle. It should be understood that the aerial vehicle can include any type of vertical takeoff and landing (VTOL) aircraft. For instance, in some implementations, the aerial vehicle can include a helicopter. In alternative implementations, the aerial vehicle can include an autonomous VTOL aircraft. For instance, the autonomous VTOL can be an electric VTOL.

As another example, a second intermediate leg 230B can include a water-based transportation service associated with transporting the user(s) from the departing waterside transportation node 210 to a destination waterside transportation node 215. The water-based transportation service can also include users (associated with other itineraries) that have arrived at the departing waterside transportation node 210 via one or more other vehicles and/or other modalities (e.g., walking, bike, scooter, etc.). The water-based transportation service 230B can include a water vehicle (e.g., a cruise ship, ferry, speed boat, etc.) configured to dock at the water-side facilities 210, 215. In this manner, user(s) can board the water vehicle. When the users are onboard the water vehicle, the water vehicle can launch and travel to the destination waterside transportation node 215. In this manner, the user(s) can deboard the water vehicle.

As yet another example, a second intermediate leg 230C can include an underground-based transportation service associated with transporting the user(s) from the departing underground transportation node 210 to a destination underground transportation node 215. The underground transportation service can also include users (associated with other itineraries) that have arrived at the departing underground transportation node 210 via one or more other vehicles and/or other modalities (e.g., walking, bike, scooter, etc.). The underground-based transportation service 230C can include an underground vehicle (e.g., a subway, underwater train, etc.) configured to stop at the underground facilities 210, 215. In this manner, user(s) can board the underground vehicle. When the users are onboard the underground vehicle, the underground vehicle can launch and travel to the destination underground transportation node 215. In this manner, the user(s) can deboard the underground vehicle.

In some implementations, the multi-modal transportation service 200 can include a second ground-based transportation service 235 associated with transporting each of the user(s) from the destination transportation node 215 to a destination location 220. The destination location 220 can include a residence (e.g., house, apartment, townhouse) for a respective user. In some implementations, the second ground-based transportation service 235 can include at least a first type of transportation modality (e.g., autonomous or human-operated vehicle) or a second type of transportation modality (e.g., walking, bicycle, scooter, etc.) that is different than the first type of transportation modality.

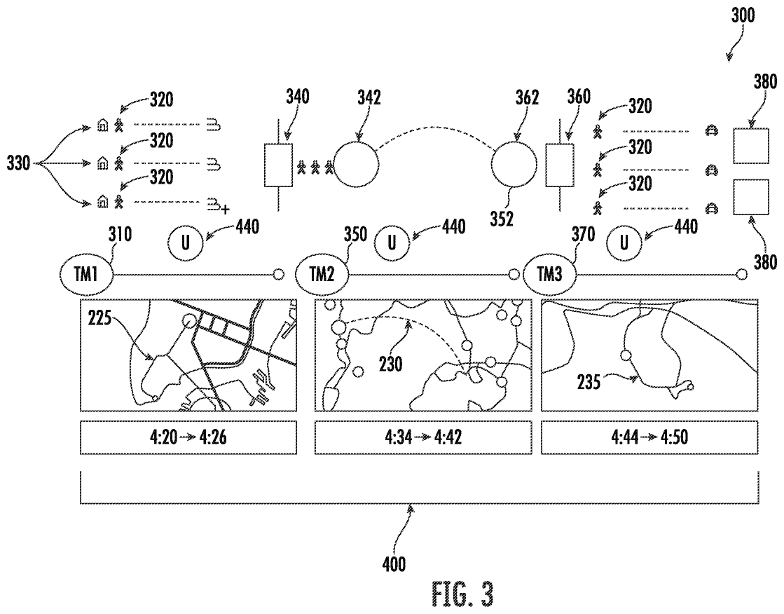

Turning to FIG. 3, FIG. 3 depicts an example user interface 300 for a multi-modal transportation service according to example embodiments of the present disclosure. The user interface 300, for example, can be provided for scheduling and/or modifying a multi-modal transportation service. The user interface 300, for example, can be associated with the ride-sharing network system 110 of FIG. 1. In some implementations, the scheduling and/or modifications of a multi-modal transportation service can be done automatically. In such a case, the user interface 300 can illustrate example operations and/or data utilized by the ride-sharing network system 110 to schedule and/or modify a multi-modal transportation service.

The multi-modal transportation service can include at least three transportation legs 310, 350, 370 between an origin location 330 and a destination location 380 of a plurality of users 320. As described above, the origin and destination location 330, 380 can be unique to each user and thus include a different and/or the same location for each of the users 320.

For example, a user (e.g., one of user(s) 320) can request a multi-modal transportation service via a user interface associated with an application (e.g., mobile app) running on a user device (e.g., smartphone, tablet, etc.) associated with the user. The user can provide information (e.g., origin location 330 destination location 380) via the user interface. Such information can be used to generate a multi-modal transportation itinerary 400 for the user.

The multi-modal transportation itinerary 400 can include at least a first leg 225 and a second leg 230. The first leg 225 can include a first (e.g., ground-based) transportation service 310 associated with transporting the user from the origin location 330 to a departing transportation node 340. The second leg 230 can include an alternative transportation service 350 (e.g., an aerial transportation service, water transportation service, underground transportation service, etc.) associated with transporting the users 320 from the departing transportation node 340 to the destination transportation node 360. In some implementations, the destination location 380 can be different than the destination transportation node 360. In such implementations, the multi-modal transportation itinerary 400 for the user can include a third leg 235 associated with transporting the users 320 from the destination transportation node 360 to the destination location 380 via another (e.g., second ground-based) transportation service 370.

The multi-modal transportation itinerary 400 for the user of the multi-modal transportation service can be affected due, at least in part, to uncertainty 440 associated with one or more legs (e.g., first leg 225, second leg 230, third leg 235) of the multi-modal transportation itinerary 400. For instance, the plurality of users 320 pooling at the departing transportation node 340 for the second leg 230 of the multi-modal transportation itinerary 400 may not arrive at the transportation node at the same time due, at least in part, to uncertainty 440 associated with the first leg 225 of the multi-modal transportation itinerary 400 for one or more of the users 320. As such, a first user arriving at the departing transportation node 340 before a second user with whom the first user will be pooling for the second leg 230 of the multi-modal transportation itinerary 400 will have to wait on the second user. This represents a time-cost to the first user, can negatively impact the first user's experience of the multi-modal transportation service, and can result in a substantial computing cost to generate last minute contingency plans for one or more of the users (e.g., first user, second user) of the multi-modal transportation service.

Uncertainty 440 can represent a level of confidence (or lack thereof) that the user/vehicle will arrive within a certain time (e.g., ETA, etc.). For example, uncertainty can be expressed as a value (e.g., a value on a 1-10 scale, etc.), a percentage, a relative level (e.g., low, medium, high, etc.), a decimal, a confidence level, a time range (e.g., +/−3 minutes, etc.), and/or in other manners. The uncertainty can be determined based, at least in part, on data indicative of one or more sources of uncertainty associated with the first leg 225. Example sources of uncertainty 440 associated with the first leg 225 will now be discussed in more detail.

The uncertainty 440, for example, can be based, at least in part, on data indicative of one or more sources of uncertainty 440 associated with the first, second, or third transportation legs 225, 230, 235. For example, uncertainty for a transportation leg can be determined based, at least in part, on multi-modal transportation data. For instance, multi-modal transportation data can be obtained and associated with a multi-modal transportation service. The multi-modal transportation data can include historical data and/or information received from one or more transportation service providers (e.g., service provider system(s) 170 of FIG. 1).

The multi-modal transportation data can include data associated with one or more candidate multi-modal transportation itineraries for the user. For example, the multi-modal transportation data can be indicative of a time of departure for each transportation leg 225, 230, 235 (e.g., a first, second, third, etc.) of the one or more candidate multi-modal transportation itineraries. In addition, or alternatively, the multi-modal transportation data can include a transportation modality (e.g., one or more ground-based, water-based, underground-based, space-based, etc.) for each of the transportation legs. In some implementations, the multi-modal transportation data can include historical data indicative of one or more events associated with at least one of the time of departure(s), the departing/arrival transportation node(s), geographic region(s) corresponding to the origin/destination locations and/or the transportation node(s), or the transportation modalities for each of the transportation legs. The uncertainty 440 associated with an estimated time-of-arrival of the user at the departing transportation node 340 can be determined based, at least in part, on the multi-modal transportation data. For example, the uncertainty 440 associated with the estimated time-of-arrival of the user at the departing transportation node 340 corresponding to the second leg 230 can be determined based, at least in part, on the historical data.

More particularly, a transportation modality (e.g., and/or the historical data thereof) for a transportation leg 225, 230, 235 can be a source of uncertainty 440. For example, the reliability of an estimated time-of-arrival can vary depending on a transportation modality. By way of example, a ground-based transportation modality can involve more uncertainty (e.g., due to traffic, and other land based factors) than aerial and/or water-based transportation modalities. In some implementations, the uncertainty 440 for a first transportation leg 225 can be determined based, at least in part, on at least one of the first transportation modality of the first transportation leg 225 and/or the second transportation modality of the second transportation leg 230.

In addition, or alternatively, geographical regions (and/or historical data thereof) associated with the origin location 330, departure/arrival nodes 340, 360, and/or destination locations 380 can be a source of uncertainty 440. By way of example, different locations can involve more uncertainty 440 (e.g., due to traffic, and other regional based factors).

For example, traffic and/or weather (and/or historical data thereof) can be a source of uncertainty 440. By way of example, autonomous and/or human-operated ground motor vehicles can encounter traffic conditions that can be a source of uncertainty 440. In this regard, time-of-day (e.g., rush-hour) and weather (e.g., rain, snow, etc.) can affect traffic conditions. As another example, aerial and/or water-based transportation modalities encounter weather conditions that can be a source of uncertainty 440. The uncertainty associated with weather and/or traffic conditions can introduce uncertainty associated with an estimated time-of-arrival of vehicles at the origin location 310, departure/arrival nodes 340, 360, and/or destination locations 380.

In some implementations, a user 320 (and/or historical data thereof) associated with a transportation leg can be a source of uncertainty 440. For instance, the user may not be ready to board a vehicle when the vehicle arrives at the origin/destination location(s) 330, 380 and/or the departure/arrival transportation node(s) 340, 360. In some instances, the ground-based transportation service may be cancelled if the user fails to board the autonomous or human-operated vehicle within a predetermined amount of time (e.g., 2 minutes) after the autonomous or human-operated vehicle arrives at the origin location. In such instances, another autonomous or human-operated vehicle may be deployed to pick up the user at the origin location 330.

In some implementations, a type of vehicle selected for the ground-based transportation service (e.g., autonomous, manual, etc.) can be a source of uncertainty 440 associated with a first leg of the initial candidate multi-modal transportation itinerary 400. For instance, historical data associated with a first type of autonomous vehicle may be better compared to historical data associated with a second type of autonomous vehicle. More specifically, the historical data can indicate that the first type of autonomous vehicle is better than the second type of autonomous vehicle at delivering a user to a drop-off location (e.g., departing transportation node) by an estimated time-of-arrival.

In some implementations, a rating associated with an operator (e.g., driver, captain, pilot, etc.) of a human-operated vehicle can be a source of uncertainty 440. For instance, historical data associated with the operator can be indicative of performance of the operator at delivering a user to a drop-off location by an estimated time-of-arrival (e.g., a lower uncertainty can be associated with operators that historically drop-off users within a window of the estimated time-of-arrival, etc.). Alternatively, or additionally, the historical data can indicate whether the operator has completed a route associated with a transportation leg (e.g., a lower uncertainty can be associated with drivers that are familiar with the route, a higher uncertainty can be associated with drivers that may not be familiar with the route, etc.).

In some implementations, the origin location 330 can be a source of uncertainty 440. For instance, historical data can indicate that users picked up at the origin location 330 arrive at the departing transportation node 340 earlier than an estimated time-of-arrival. Alternatively, historical data can indicate that users picked up at the origin location 330 arrive at the departing transportation node 340 later than the estimated time-of-arrival.

It should be understood that sources of uncertainty 440 associated with the first leg 225 of the multi-modal transportation itinerary 400 for a user 320 can affect an estimated time-of-arrival of the user at the departing transportation node 340. Stated another way, uncertainty 440 associated with the estimated time-of-arrival of the user 320 at the departing transportation node 340 can be a function of the sources of uncertainty 440 associated with the first leg 225 of the multi-modal transportation itinerary 400 for the user 320. As will be discussed in more detail, the multi-modal transportation itinerary 400 for one or more of the users 320 can be modified based, at least in part, on the uncertainty 440 associated with one or more legs (e.g., first leg 225, second leg 230, third leg 235) of the multi-modal transportation itinerary 400.

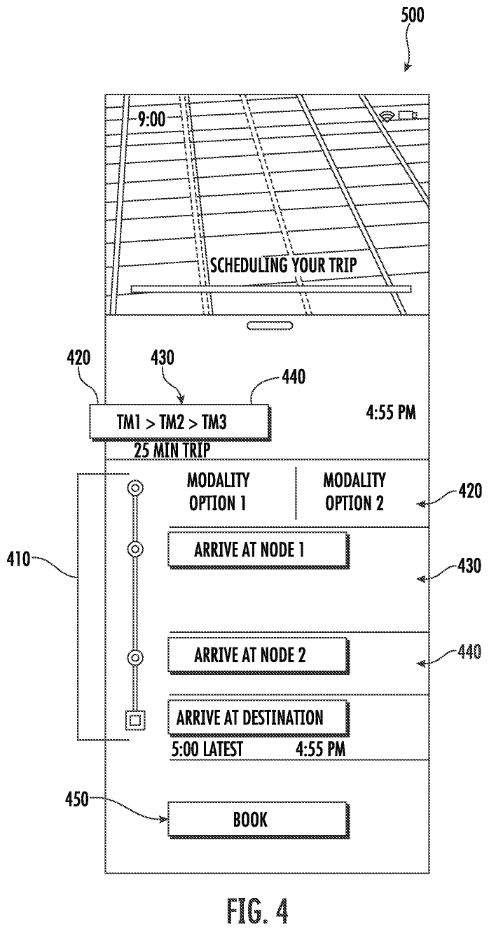

Referring now to FIG. 4, FIG. 4 depicts an example user interface 500 for a modifying a multi-modal transportation service according to example embodiments of the present disclosure. The example user interface 500 can include a user interface provided by an application running on a user device (e.g., smartphone, tablet, etc.). As shown, the user interface 500 can be displayed via a display device (e.g., screen, etc.) and can present an updated candidate multi-modal transportation itinerary 410. The updated candidate multi-modal transportation itinerary 410 can include at least a first leg 420 and a second leg 430. The first leg 420 can include a first ground-based transportation service associated with transporting the user from the origin location to the departing transportation node. The type of transportation modality associated with the first leg 420 can be a ground-based transportation modality determined via the above-described uncertainty calculation. The second leg 430 can include a transportation service associated with transporting the user from the departing transportation node to the destination transportation node.

In some implementations, the destination location for the user may be different than the destination transportation node. In such implementations, the updated candidate multi-modal transportation itinerary 410 can include a third leg 440. The third leg 440 can include a second ground-based transportation service associated with transporting the user from the destination transportation node to the destination location. As will be discussed below, the user interface 500 can, in some implementations, display information associated with one or more legs (e.g., first leg 420, second leg 430, third leg 440) of the updated candidate multi-modal transportation itinerary 410.

In some implementations, the user interface 500 can display information associated with the first leg 420 of the updated candidate multi-modal transportation itinerary 410. For example, the user interface 500 can display a type of transportation modality for the first ground-based transportation service. In some implementations, the user interface 500 can display multiple options for the type of transportation modality of the first ground-based transportation service. For example, the user interface 500 can display at least a first type of transportation modality (e.g., autonomous or human-operated vehicle) and a second type of transportation modality (e.g., walking, bicycle, scooter, etc.) for the first ground-based transportation service. In some implementations, the origin location associated with the second type of transportation modality can be different than the first type of transportation modality. For example, the origin location for a bicycle can be the location of the bicycle, which can be different than the origin location (e.g., residence of the user) specified for a human-operated vehicle (e.g., automobile).

In some implementations, the user interface 500 can prioritize the different types (e.g., first type, second type) of transportation modality for the first ground-based transportation service based, at least in part, on an uncertainty associated with each type (e.g., first type, second type). For instance, the second type of transportation modality may be presented higher and/or more prominently on the user interface than the first type of transportation modality. As such, the user interface 500 may display the second type of transportation modality as a preferred type of transportation modality for the first ground-based transportation service. Additionally, the user interface 500 may display the first type of transportation modality as an alternate type of transportation modality. Furthermore, in some implementations, the user interface 500 may incentivize the user to select the preferred type of transportation modality for the first ground-based transportation service. For example, the user interface 500 may offer the user one or more incentives (e.g., reward points, discounts, etc.) if the user selects the preferred type of transportation modality for the first ground-based transportation service.

In some implementations, the user interface 500 can display information associated with the second leg 430 of the updated candidate multi-modal transportation itinerary 410. For example, the user interface 500 can display information for multiple flights associated with the aerial-based transportation service. In some implementations, the user interface 500 can display information for a first flight departing from a first transportation node. Additionally, the user interface 500 can display information for a second flight departing from a second transportation node that is closer to the origin location.

In some implementations, the user interface 500 can prioritize the different routes (e.g., first aerial-, water-, underground-route, first aerial-, water-, underground-route) based, at least in part, on an uncertainty associated with each route. For instance, the uncertainty associated with the user arriving at the second transportation node on-time may be lower than the uncertainty associated with the user arriving at the first transportation node on-time. As such, the user interface 500 may display the second route as a preferred transportation service for the second leg 430 of the updated candidate multi-modal transportation itinerary 410. Additionally, the user interface 500 may display the first route as an alternate transportation service for the second leg 430 of the updated candidate multi-modal transportation itinerary 410. Furthermore, in some implementations, the user interface 500 may incentivize the user to select the preferred transportation service. For example, the user interface 500 may offer the user one or more incentives (e.g., reward points, discounts, etc.) if the user selects the preferred transportation service for the second leg 430 of the updated candidate multi-modal transportation itinerary 410.

In some implementations, the user interface 500 can display multiple options for the type of transportation modality of the second ground-based transportation service associated with the third leg 440 of the updated candidate multi-modal transportation itinerary. For example, the user interface 500 can display at least a first type of transportation modality (e.g., autonomous or human-operated vehicle) and a second type of transportation modality (e.g., walking, bicycle, scooter, etc.) for the second ground-based transportation service. These options can be determined based, at least in part, on uncertainty associated with the same or previous legs to try to help a user arrive at the destination location at or before an estimated time-of-arrival.

In some implementations, the user interface 500 can prioritize the different types (e.g., first type, second type) of transportation modality for the second ground-based transportation service based, at least in part, on an uncertainty associated with each type (e.g., first type, second type). For instance, the uncertainty associated with the second type of transportation modality may be lower than the uncertainty associated with the first type of transportation modality. As such, the user interface 500 may display the second type of transportation modality as a preferred type of transportation modality for the second ground-based transportation service. Additionally, the user interface 500 may display the first type of transportation modality as an alternate type of transportation modality. Furthermore, in some implementations, the user interface 500 may incentivize the user to select the preferred type of transportation modality for the second ground-based transportation service. For example, the user interface 500 may offer the user one or more incentives (e.g., reward points, discounts, etc.) if the user selects the preferred type of transportation modality for the second ground-based transportation service. The preferred type of transportation modality for the second ground-based transportation service can be the type of transportation modality that is most likely for the user to arrive at the destination location at or before the estimated time-of-arrival.

In some implementations, the user interface 500 can include one or more interface elements 450 (e.g., button, toggle, etc.). In such implementations, the user can interact (e.g., touch) with the one or more user elements 450 to confirm selection of the updated candidate multi-modal transportation itinerary 410. It should be understood however that the user can confirm selection of the updated candidate multi-modal transportation itinerary 410 in any suitable manner. For instance, in alternative implementations, the user can confirm selection of the updated candidate multi-modal transportation itinerary 410 via one or more non-contact gestures (e.g., voice command).

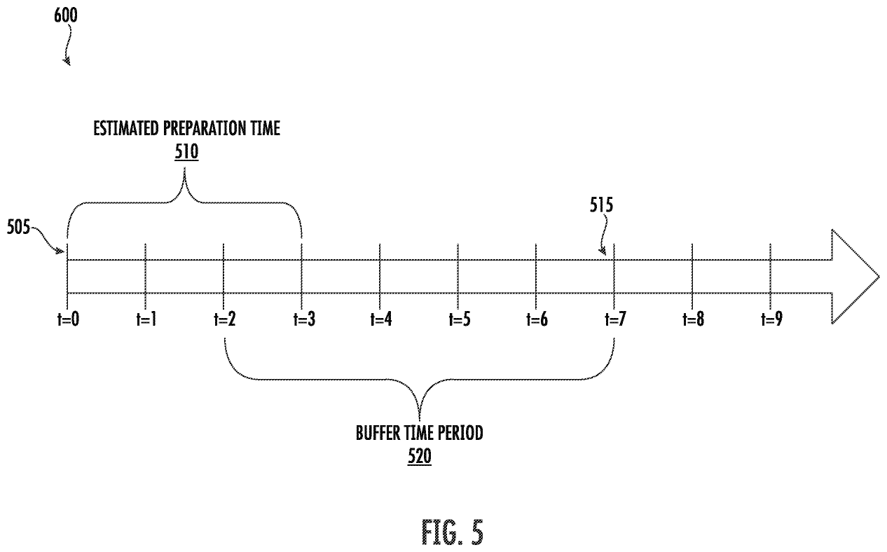

Referring now to FIG. 5, depicts an example timing 600 for an example transportation leg of a multi-modal transportation itinerary. The timing 600 of an example transportation leg can include a start time 505, an estimated preparation time period 510, and a departure time 515. The start time 505 can identify a scheduled time-of-arrival for a user at a departing transportation node. The start 505 can be scheduled at least early enough to allow the estimated preparation time period 510 to elapsed between the arrival of a passenger and the estimated time of departure 515.

In some implementations, an uncertainty can be determined for the estimated time-of-arrival 505 based, at least in part, on a time difference between the estimated time-of-arrival 505 of the user at the departing transportation node corresponding to a second leg and the departure time 515 of a transportation service associated with the departing transportation node.

For example, at times, the transportation service at the departing transportation node can include a transportation schedule. The transportation schedule, for example, can include a plurality of scheduled departure, maintenance, and/or arrival times for a plurality of assets of a certain transportation modality (e.g., aerial-, ground-, underground-, water-based, etc.). By way of example, in the event that the second transportation modality is an aerial-based transportation modality, the transportation schedule can include a flight schedule descriptive of a plurality of take-off times/locations, landing times/locations, boarding times/locations, maintenance times/locations, etc. for each of a plurality of assets of one or more aerial transportation service providers. As another example, in the event that the second transportation modality is a water-based transportation modality, the transportation schedule can include a schedule descriptive of a plurality of departure times/locations, arrival times/locations, boarding times/locations, maintenance times/locations, etc. for each of a plurality of assets of one or more water transportation service providers.

One or more modifications to a multi-modal transportation itinerary can be determined based, at least in part, on the uncertainty associated with the estimated time-of-arrival 505. For instance, if the uncertainty associated with the estimated time-of-arrival 505 of the user at the departing transportation node is high (e.g., greater than about 50 percent, greater than about 60 percent, greater than about 70 percent, etc.), the one or more modifications to the multi-modal transportation itinerary can include moving the user to a service with a later departure time. In this manner, other users pooling with the user at the departing transportation node will not be inconvenienced due to the high uncertainty associated with the estimated time-of-arrival 505 of the user at the departing transportation node. Alternatively, if the uncertainty associated with the estimated time-of-arrival 505 of the user at the departing aerial transportation node is low (e.g., less than about 30 percent, less than about 20 percent, etc.), the one or more modifications can include delaying (e.g., holding) the departure time 515 of the transportation service for the user.

In some implementations, the one or more modifications to the multi-modal transportation itinerary can be based, at least in part, a buffer time period 520. The buffer time period 520 can be indicative of a threshold amount of time that a user can wait before the departure of the next transportation service. By way of example, the one or more modifications to the multi-modal transportation itinerary can be based on whether one or more waiting users with whom an enroute user will be pooling with for a second leg of the multi-modal transportation itinerary have already arrived at the departing transportation node. For instance, when the uncertainty associated with the estimated time-of-arrival 505 of the enroute user at the departing transportation node is low and one or more waiting users pooling with the enroute user for the second leg have already arrived at the departing transportation node (e.g., have been or are predicted to wait for a time period longer than the buffer time period 520), the one or more modifications can include booking the enroute user on a transportation service with a later departure time to prevent the waiting users from waiting for longer than a buffer time period. In this manner, one or more users already at a departing transport node will not be inconvenienced by having to wait for longer than a buffer time period 520 (e.g., about 8 minutes). As used herein, use of the term “about” refers to range of numerical values within 25 percent of the stated numerical value.

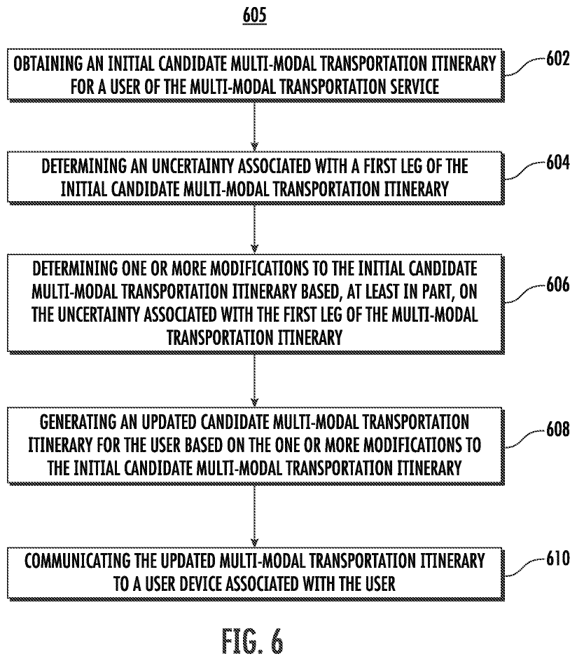

FIG. 6 is a flowchart of a method 605 for generating an updated candidate multi-modal transportation itinerary based on uncertainty associated with a first leg of an initial candidate multi-modal transportation itinerary, according to some aspects of the present disclosure. One or more portion(s) of the method 605 can be implemented by a computing system that includes one or more computing devices such as, for example, the computing systems described with reference to the other figures (e.g., ride-sharing network system 110, passenger computing device(s) 130, transportation service provider computing device(s) 150, service provider system(s) 170, etc.). Each respective portion of the method 605 can be performed by any (or any combination) of one or more computing devices. Moreover, one or more portion(s) of the method 605 can be implemented as an algorithm on the hardware components of the device(s) described herein (e.g., as in FIG. 1, etc.), for example, to generate an updated candidate multi-modal transportation itinerary as discussed herein. FIG. 6 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 6 is described with reference to elements/terms described with respect to other systems and figures for exemplary illustrated purposes and is not meant to be limiting. One or more portions of method 605 can be performed additionally, or alternatively, by other systems.

At (602), the method 605 can include obtaining an initial candidate multi-modal transportation itinerary for a user of the multi-modal transportation service. For example, a computing system (e.g., ride-sharing network system 110, scheduling & mitigation system 124, etc.) can obtain the initial candidate multi-modal transportation itinerary for the user of the multi-modal transportation service. The initial candidate multi-modal transportation itinerary can include at least a first leg and a second leg. The first leg can include a first ground-based transportation service associated with transporting the user from an origin location to a departing transportation node. The second leg can include another transportation service associated transporting the user from the departing transportation node to a destination transportation node. The transportation service associated with the second leg can include a service using one or more vehicles associated with one or more modalities (e.g., public transit, railway, aerial-vehicles, underground vehicles, water-vehicles, etc.) or mediums (e.g., ground, water, air, space, underground, etc.) different from the ground-based modality of the first leg. In some implementations, the initial candidate multi-modal transportation itinerary can include a third leg. In such implementations, the third leg can include a second ground-based transportation service associated with transporting the user from the destination transportation node to a destination location (e.g., requested by the user, etc.).

At (604), the method 605 can include determining an uncertainty associated with a first leg of the initial candidate multi-modal transportation itinerary. For example, the computing system can determine the uncertainty associated with the first leg of the initial candidate multi-modal transportation itinerary. For instance, the computing system can be configured to determine the uncertainty based, at least in part, on multi-modal transportation data indicative of one or more sources of uncertainty associated with the first leg. It should be understood that the one or more sources of uncertainty associated with the first leg can include one or more of the sources discussed herein.

For instance, the computing system can include a weighting algorithm that is configured to utilize the various sources of uncertainty to calculate an aggregate uncertainty for the first leg. By way of example, the computing system can determine that given the current traffic conditions, an autonomous vehicle (e.g., automobile) would potentially be delayed by 1 minute. Furthermore, based on the user profile, the computing system can determine that the user is historically 2 minutes late to board a vehicle at an origin location. Thus, the computing system can aggregate these sources to determine that there is an uncertainty of +3 minutes (e.g., a potential three minute delay) associated with the first transportation leg.

At (606), the method 605 can include determining one or more modifications to the initial candidate multi-modal transportation itinerary based, at least in part, on the uncertainty associated with the first leg of the multi-modal transportation itinerary. For example, the computing system can determine the one or more modifications to the initial candidate multi-modal transportation itinerary based, at least in part, on the uncertainty associated with the first leg of the multi-modal transportation itinerary. In some implementations, the one or more modifications can include modifying the type of transportation modality for a first ground-based vehicle service. For instance, modifying the type of transportation modality for the first ground-based vehicle service can include switching the type of transportation modality for the first ground-based vehicle service from a first type of transportation modality (e.g., autonomous vehicle or human-operated vehicle) to a second type of transportation modality (e.g., bicycle, scooter, etc.) that is different than the first type of transportation modality. The second type of transportation modality (e.g., walking, bicycle, etc.) can lower the uncertainty associated with the first leg, because the second type of transportation modality can, for example, help avoid certain sources of uncertainty (e.g., high automobile traffic, a would-be assigned driver, avoid a delay due to the user boarding a vehicle, etc.) associated with the first type of transportation modality.

Alternatively, or additionally, the one or more modifications can include modifying a location of the departing transportation node. For instance, modifying the location of the departing transportation node can include switching the departing transportation node from a first transportation node at a first location to a second transportation node at a second location that is different than the first location.

In some implementations, the second location can be closer to the origin location than the first location. In such implementations, sources of uncertainty (e.g., traffic conditions, weather, time-of-day) associated with the first leg can be reduced, because a distance from the origin location to the departing transportation node (that is, the second transportation node at the second location) is reduced. In alternative implementations, the second location can be farther from the origin location than the first location. As such, a route associated with traveling from the origin location to the second transportation node is longer than a route associated with traveling from the origin location to the first transportation node. In such implementations, the route associated with traveling from the origin location to the second transportation node may be less affected by sources of uncertainty (e.g., traffic) than the route associated with traveling from the origin location to the first transportation node. As such, uncertainty associated with the first leg can be reduced, because modifying the departing transportation node from the first transportation node to the second transportation node can, for example, reduce or eliminate sources of uncertainty (e.g., traffic conditions, weather, time-of-day) associated with transporting the user from the origin location to the departing transportation node.

In some implementations, the vehicle associated with the second leg of the initial candidate multi-modal transportation itinerary can be assigned and/or updated based on the location of the departing transportation node being switched from the first transportation node to the second transportation node. This may occur even though a distance of the second leg of the multi-modal transportation itinerary is increased.

At (608), the method 605 can include generating an updated candidate multi-modal transportation itinerary for the user based on the one or more modifications to the initial candidate multi-modal transportation itinerary. For example, the computing system can generate the updated candidate multi-modal transportation itinerary for the user based on the one or more modifications to the initial candidate multi-modal transportation itinerary. In some implementations, the first leg of the updated candidate multi-modal transportation itinerary can be different than the first leg of the initial candidate multi-modal transportation itinerary. For instance, the type of transportation modality of the ground-based transportation service for the first leg of the updated candidate multi-modal transportation itinerary can be different than the type of transportation modality of the ground-based transportation service for the first leg of the initial candidate multi-modal transportation itinerary. Alternatively, or additionally, the departing transportation node associated with the updated candidate multi-modal transportation itinerary can be different than the departing transportation node for the second leg of the initial candidate multi-modal transportation itinerary. For example, the departing transportation node associated with the updated candidate multi-modal transportation itinerary can be closer to the origin location than the departing transportation node associated with the initial candidate multi-modal transportation itinerary.

At (610), the method 605 can include communicating the updated multi-modal transportation itinerary to a user device associated with the user. For example, the computing system can communicate the updated multi-modal transportation itinerary to the user device associated with the user. For instance, the user device. For instance, in some implementations, the updated candidate multi-modal transportation itinerary can be displayed on a user interface running on the user device. In this manner, the user can view the updated candidate multi-modal transportation itinerary. The user can select the updated candidate multi-modal transportation itinerary via the user interface (e.g., via a touch-based user input, etc.). The initial candidate multi-modal transportation itinerary can be an internal itinerary (e.g., a computational starting point) used for determining an optimal itinerary given the potential uncertainty associated with a transportation leg. Accordingly, the initial candidate multi-modal transportation itinerary may not be displayed/presented to a user.

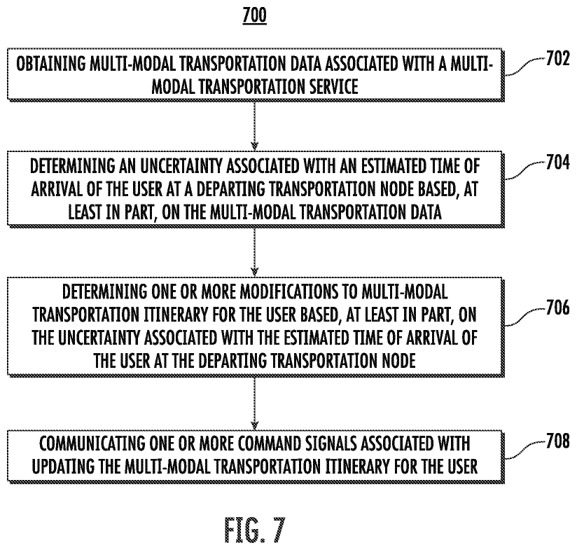

FIG. 7 depicts another flow diagram 700 of a method for generating an updated candidate multi-modal transportation itinerary based on uncertainty associated with at least one leg of an initial candidate multi-modal transportation itinerary according to example embodiments of the present disclosure. One or more portion(s) of the method 700 can be implemented by a computing system that includes one or more computing devices such as, for example, the computing systems described with reference to the other figures (e.g., ride-sharing network system 110, passenger computing device(s) 130, transportation service provider computing device(s) 150, service provider system(s) 160, etc.). Each respective portion of the method 700 can be performed by any (or any combination) of one or more computing devices. Moreover, one or more portion(s) of the method 700 can be implemented as an algorithm on the hardware components of the device(s) described herein (e.g., as in FIG. 1, etc.), for example, to generate an updated candidate multi-modal transportation itinerary as discussed herein. FIG. 7 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 7 is described with reference to elements/terms described with respect to other systems and figures for exemplary illustrated purposes and is not meant to be limiting. One or more portions of method 700 can be performed additionally, or alternatively, by other systems.

At (702), the method 700 can include obtaining multi-modal transportation data associated with a multi-modal transportation service. For example, a computing system (e.g., ride-sharing network system 110, scheduling & mitigation system 124, etc.) can obtain the multi-modal transportation data associated with the multi-modal transportation service. In some implementations, the multi-modal transportation data can be associated with a multi-modal transportation itinerary for a user. The multi-modal transportation itinerary can include at least a first leg and a second leg. The first leg can include a first ground-based transportation service associated with transporting the user from an origin location to a departing transportation node. The second leg can include another transportation service associated with transporting the user from the departing transportation node to a destination transportation node. In some implementations, the user may be traveling to a destination location that is different than the destination transportation node. In such implementations, the multi-modal transportation itinerary can include a third leg. The third leg can include a second ground-based transportation service associated with transporting the user from the destination transportation node to the destination location.

In some implementations, the multi-modal transportation data can include a departure time for a transportation service associated with second leg of the multi-modal transportation itinerary for the user. However, it should be understood that the multi-modal transportation data can include any data associated with one or more legs (e.g., first leg, second leg, third leg) of the multi-modal transportation itinerary for the user. For instance, in some implementations, the multi-modal transportation data can include a type of transportation modality of the first ground-based transportation service associated with the first leg. The multi-modal transportation data can indicate the transportation modalities associated with one or more legs, the routes, particular vehicles, vehicle history (e.g., number of trips, familiarity with area, etc.), operating conditions (e.g., vehicle capabilities, traffic conditions, weather conditions, etc.), timing parameters (e.g., ETAs, etc.), information associated with the user (e.g., name/identifier, user profile, historical user data, etc.), and/or other information.

At (704), the method 700 can include determining an uncertainty associated with an estimated time-of-arrival of the user at a departing transportation node based, at least in part, on the multi-modal transportation data. For example, the computing system can determine the uncertainty associated with the estimated time-of-arrival of the user at the departing transportation node based, at least in part, on the multi-modal transportation data. In some implementations, the method 700 can include determining the uncertainty associated with the estimated time-of-arrival based, at least in part, on a time difference between the estimated time-of-arrival of the user at the departing transportation node and the departure time of the transportation service associated with the second leg. For instance, the uncertainty associated with the estimated time-of-arrival can be a function of the time difference (e.g., uncertainty increases as magnitude of time difference increase, uncertainty decreases as magnitude of time difference decreases).

In some implementations, the computing system can be configured to classify uncertainty associated with the estimated time-of-arrival of the user at the departing transportation node based, at least in part, on the time difference. For instance, the computing system can be configured to determine uncertainty associated with the estimated time-of-arrival of the user at the departing transportation node is low (e.g., less than 50 percent, less than 40 percent, less than 30 percent, less than 20 percent, etc.) when the time difference is smaller than a threshold value (e.g., about 5 minutes). Alternatively, the computing system can be configured to determine uncertainty associated with the estimated time-of-arrival of the user at the departing transportation node is high (e.g., greater than 50 percent, greater than 60 percent, greater than 60 percent, greater than 80 percent, etc.) when the time difference is larger than the threshold value.

At (706), the method 700 can include determining one or more modifications to a multi-modal transportation itinerary for the user based, at least in part, on the uncertainty associated with the estimated time-of-arrival of the user at the departing transportation node. For example, the computing system can determine one or more modifications to the multi-modal transportation itinerary for the user based, at least in part, on the uncertainty associated with the estimated time-of-arrival of the user at the departing transportation node. For instance, when the uncertainty associated with the estimated time-of-arrival of the user at the departing transportation node is high (e.g., greater than t 50 percent, greater than 60 percent, greater than 60 percent, etc.), the one or more modifications to the multi-modal transportation itinerary can include moving the user to a later service. In this manner, other users pooling with the user at the departing transportation node will not be inconvenienced due to the high uncertainty associated with the estimated time-of-arrival of the user at the departing transportation node. Alternatively, when the uncertainty associated with the estimated time-of-arrival of the user at the departing transportation node is low (e.g., less than 50 percent, less than about 40 percent, less than 30 percent, less than 20 percent, etc.), the one or more modifications determined by the computing system can include holding the service for the user.

In some implementations, the one or more modifications to the multi-modal transportation itinerary can be based, at least in part, on whether one or more users with whom the user will be pooling with for the second leg of the multi-modal transportation itinerary have already arrived at the departing transportation node. For example, when the computing system determines the uncertainty associated with the estimated time-of-arrival of the user at the departing transportation node is low and one or more users pooling with the user for the second leg have already arrived at the departing transportation node (and have been or are predicted to wait over a threshold time), the one or more modifications can include booking the user on the later service. In this manner, instances can be avoided in which a service is held for the user at the inconvenience of one or more users pooling with the user for the second leg.

In some implementations, the estimated time-of-arrival of the user at the departing transportation node may be earlier than an estimated time-of-arrival of one or more users pooling with the user at the departing transportation node for the second leg of the multi-modal transportation itinerary. In such implementations, the one or more modifications to the multi-modal transportation itinerary for the user can include adjusting one or more parameters associated with the first leg of the multi-modal transportation itinerary for the user. More specifically, the one or more parameters associated with the first leg can be adjusted such that the user arrives at the departing transportation node at substantially the same time (e.g., less than about 10 minutes, less than about 5 minutes, less than about 2 minutes, etc.) as the one or more pooling with the user at the departing transportation node for the second leg.

In implementations in which an autonomous vehicle transports the user from the origin location to the departing transportation node, adjusting the one or more parameters associated with the first leg can include reducing a speed of the autonomous vehicle as needed to prolong the first leg such that the user arrives at the departing transportation node at substantially the same time as the one or more users with whom the user will be pooling for the second leg. For instance, the speed of the autonomous vehicle can be reduced as needed such that the estimated time-of-arrival of the user at the departing transportation node is substantially the same as the estimated time-of-arrival of the one or more users with whom the user will be pooling for the second leg.

Alternatively, or additionally, adjusting the one or more parameters can include modifying a route the autonomous vehicle travels to transport the user from the origin location to the departing transportation node. For instance, the route can be modified as needed to prolong the first leg such that the user arrives at the departing transportation node at substantially the same time as the one or more users with whom the user will be pooling for the second leg.

In implementations in which a human operated vehicle transports the user from the origin location to the departing transportation node, adjusting the one or more parameters associated with the first leg can include modifying a route the human-operated vehicle travels to transport the user from the origin location to the departing transportation node. For instance, the route can be modified as needed to prolong the first leg such that the user arrives at the departing transportation node at substantially the same time as the one or more users with whom the user will be pooling for the second leg. Alternatively, or additionally, adjusting the or more parameters associated with the first leg can include adjusting what time the autonomous or human-operated vehicle arrives at the origin location to pick up the user. For instance, the time at which the autonomous or human-operated vehicle is scheduled to arrive at the origin location can be delayed as needed such that the user arrives at the departing transportation node at substantially the same time as the one or more users with whom the user will be pooling for the second leg.

At (708), the method 700 can include communicating one or more command signals associated with updating the multi-modal transportation itinerary for the user. For example, the computing system can communicate the one or more command signals associated with updating the multi-modal transportation itinerary for the user. In some implementations, the one or more command signals can be associated with generating an updated multi-modal transportation itinerary for the user. For example, when the user is being moved to a later service to accommodate the high uncertainty associated with the estimated time-of-arrival of the user at the departing transportation node, the updated multi-modal transportation itinerary can include information associated with the later service. As another example, when the service is being delayed to accommodate the user, the one or more command signals can be associated with providing one or more notifications indicative of the new departure time to the user and one or more other users with whom the user will be pooling for the second leg of the multi-modal transportation itinerary.

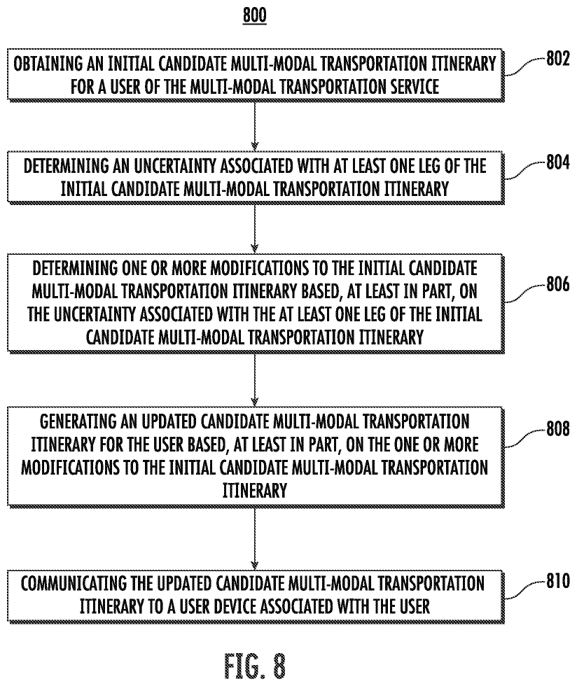

FIG. 8 depicts another flow diagram of a method 800 for generating an updated candidate multi-modal transportation itinerary based on uncertainty associated with at least one leg of an initial candidate multi-modal transportation itinerary according to example embodiments of the present disclosure. One or more portion(s) of the method 800 can be implemented by a computing system that includes one or more computing devices such as, for example, the computing systems described with reference to the other figures (e.g., ride-sharing network system 110, passenger computing device(s) 130, transportation service provider computing device(s) 150, service provider system(s) 170, etc.). Each respective portion of the method 800 can be performed by any (or any combination) of one or more computing devices. Moreover, one or more portion(s) of the method 800 can be implemented as an algorithm on the hardware components of the device(s) described herein (e.g., as in FIG. 1, etc.), for example, to generate an updated candidate multi-modal transportation itinerary as discussed herein. FIG. 8 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 8 is described with reference to elements/terms described with respect to other systems and figures for exemplary illustrated purposes and is not meant to be limiting. One or more portions of method 800 can be performed additionally, or alternatively, by other systems.

At (802), the method 800 can include obtaining an initial candidate multi-modal transportation itinerary for a user of the multi-modal transportation service. For example, a computing system (e.g., ride-sharing network system 110, scheduling & mitigation system 124, etc.) can obtain the initial candidate multi-modal transportation itinerary for the user of the multi-modal transportation service. The initial candidate multi-modal transportation itinerary can include at least a first leg and a second leg. The first leg can include a first ground-based transportation service associated with transporting the user from an origin location to a departing transportation node. The second leg can include another transportation service associated transporting the user from the departing transportation node to a destination transportation node. In some implementations, the initial candidate multi-modal transportation itinerary can include a third leg. In such implementations, the third leg can include a second ground-based transportation service associated with transporting the user from the destination transportation node to a destination location (e.g., requested by the user, etc.).

At (804), the method 800 can include determining an uncertainty associated with at least one leg of the initial candidate multi-modal transportation itinerary. For example, the computing system can determine the uncertainty associated with at least one leg of the initial candidate multi-modal transportation itinerary. For instance, in some implementations, the method 800 can include determining an uncertainty associated with the first leg of the initial candidate multi-modal transportation itinerary as described herein. Alternatively, or additionally, the method 800 can include determining an uncertainty associated with the third leg of the initial candidate multi-modal transportation itinerary.

It should be understood that uncertainty associated with the third leg of the initial candidate multi-modal transportation itinerary can be determined in manners similar to those described herein for the first leg. For example, the uncertainty associated with the third leg can be determined based, at least in part, a type of transportation modality for the second ground-based transportation service associated with the third leg of the initial candidate multi-modal transportation itinerary. In some implementations, the uncertainty associated with the third leg can be determined based, at least in part, on data specific to the type of transportation modality of the second ground-based transportation service. For instance, if the type of transportation modality of the second ground-based transportation service corresponds to a first type of transportation modality (e.g., automated or human-operated vehicle), uncertainty associated with the third leg can be determined based, at least in part, on data indicative of the autonomous vehicle's/driver's familiarity with a route to the destination transportation node. Alternatively, or additionally, the uncertainty associated with the third leg can be determined based, at least in part, on the autonomous vehicle's/driver's history of picking-up and/or dropping-off a user on time. In some implementations, the uncertainty associated with the third leg can be determined based, at least in part, on traffic conditions and/or weather.

At (806), the method 800 can include determining one or more modifications to the initial candidate multi-modal transportation itinerary based, at least in part, on the uncertainty associated with the at least one leg of the initial candidate multi-modal transportation itinerary. For example, the computing system can determine the one or more modifications to the initial candidate multi-modal transportation itinerary based, at least in part, on the uncertainty associated with the at least one leg of the initial candidate multi-modal transportation itinerary. In some implementations, the one or more modifications can include adjusting a type of transportation modality of the first ground-based transportation service of the first leg, the second ground-based transportation service of the third leg, or both. For instance, the type of transportation modality of the first ground-based transportation service (of the first leg), the second ground-based transportation service (of the third leg), or both can be adjusted to avoid a violation of an estimated time-of-arrival of the user at the destination location (e.g., airport, waterside facility, etc.). This modification(s) can be made to reduce the uncertainty associated with the candidate itinerary.

At (808), the method 800 can include generating an updated candidate multi-modal transportation itinerary for the user based, at least in part, on the one or more modifications to the initial candidate multi-modal transportation itinerary. For example, the computing system can generate the updated candidate multi-modal transportation itinerary for the user based, at least in part, on the one or more modifications to the initial candidate multi-modal transportation itinerary. For instance, a type of transportation modality of the first leg of the updated candidate multi-modal transportation itinerary can be different than a type of transportation modality of the first leg of the initial candidate multi-modal transportation itinerary. Alternatively, or additionally, a type of transportation modality of the third leg of the updated candidate multi-modal transportation itinerary can be different than a type of transportation modality of the third leg of the initial candidate multi-modal transportation itinerary.

At (810), the method 800 can include communicating the updated candidate multi-modal transportation itinerary to a user device associated with the user. For example, the computing system can communicate the updated candidate multi-modal transportation itinerary to a user device associated with the user. For instance, in some implementations, the updated candidate multi-modal transportation itinerary can be displayed on a user interface running on the user device. In this manner, the user can view the updated candidate multi-modal transportation itinerary. The user can select the updated candidate multi-modal transportation itinerary via the user interface (e.g., via a touch-based user input, etc.).

While the present subject matter has been described in detail with respect to specific example embodiments and methods thereof, it will be appreciated that those skilled in the art, upon attaining an understanding of the foregoing can readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A computing system comprising:
one or more processors; and
one or more non-transitory computer-readable media that collectively store instructions that, when executed by the one or more processors, cause the computing system to perform operations, the operations comprising:
obtaining an initial candidate multi-modal transportation itinerary for a user, the initial candidate multi-modal transportation itinerary comprising a first leg and a second leg, wherein the first leg comprises a first transportation service to a departing transportation node associated with the second leg;
determining an uncertainty associated with the first leg of the initial candidate multi-modal transportation itinerary;
determining one or more modifications to the initial candidate multi-modal transportation itinerary based, at least in part, on the uncertainty associated with the first leg of the initial candidate multi-modal transportation itinerary;
generating an updated candidate multi-modal transportation itinerary for the user based, at least in part, on the one or more modifications to the initial candidate multi-modal transportation itinerary; and
communicating, to a user device, data associated with the updated candidate multi-modal transportation itinerary.

2. The computing system of claim 1, wherein the uncertainty is associated with an estimated time-of-arrival of the user at the departing transportation node.

3. The computing system of claim 1, wherein:
determining the uncertainty associated with the first leg of the initial candidate transportation itinerary comprises determining the uncertainty based, at least in part, on a transportation modality of the first transportation service of the first leg.

4. The computing system of claim 3, wherein:
determining one or more modifications to the initial candidate multi-modal transportation itinerary comprises switching the transportation modality from a first type of transportation modality to a second type of transportation modality that is different than the first type; and
generating the updated candidate multi-modal transportation itinerary for the user comprises generating the updated candidate multi-modal transportation itinerary with the second type of transportation modality for the first leg.

5. The computing system of claim 4, wherein:
the first type of transportation modality comprises a human operated vehicle; and
the second type of transportation modality comprises an autonomous vehicle.

6. The computing system of claim 4, wherein:
the first type of transportation modality comprises an autonomous vehicle or a human operated vehicle; and
the second type of transportation modality comprises walking or a light electric vehicle.

7. The computing system of claim 1, wherein:
determining one or more modifications to the initial candidate multi-modal transportation itinerary comprises modifying a location of the departing transportation node from a first transportation node at a first location to a second transportation node at a second location that is different than the first location.

8. The computing system of claim 4, wherein the user device is configured to present a user interface indicative of the updated candidate multi-modal transportation itinerary, wherein the first type of transportation modality and the second type of transportation modality are presented as transportation options for the first leg, and wherein the second type of transportation modality is prioritized over the first type of transportation modality.

9. A computer-implemented method comprising:
obtaining, by a computing system comprising one or more computing devices, multi-modal transportation data associated with a multi-modal transportation service, the multi-modal transportation data comprising data associated with a multi-modal transportation itinerary for a user, the multi-modal transportation itinerary comprising a first leg and a second leg, the first leg comprising a first transportation service for a user to a departing transportation node from an origin location;
determining, by the computing system, an uncertainty associated with an estimated time-of-arrival of the user at the departing transportation node based, at least in part, on the multi-modal transportation data;
determining, by the computing system, one or more modifications to the multi-modal transportation itinerary for the user based, at least in part, on the uncertainty associated with the estimated time-of-arrival; and
communicating, by the computing system, one or more command signals associated with updating the multi-modal transportation itinerary according to the one or more modifications.

10. The computer-implemented method of claim 9, wherein determining the one or more modifications to the multi-modal transportation itinerary comprises:
modifying, by the computing system, a location of the departing transportation node from a first transportation node at a first location to a second transportation node at a second location that is different than the first location.

11. The computer-implemented method of claim 9, wherein determining the one or more modifications to the multi-modal transportation itinerary comprises:
in response to detecting that the estimated time-of-arrival of the user at the departing transportation node is earlier than an estimated time-of-arrival of one or more users pooling with the user at the departing transportation node for the second leg, adjusting, by the computing system, one or more parameters associated with the first leg of the multi-modal transportation itinerary such that the user arrives at the departing transportation node at substantially the same time as the one or more users with whom the user will be pooling for the second leg.

12. The computer-implemented method of claim 11, wherein:
the first transportation service comprises an autonomous vehicle; and
adjusting one or more parameters comprises providing one or more command signals associated with reducing a speed of the autonomous vehicle.

13. The computer-implemented method of claim 11, wherein the first transportation service comprises an autonomous vehicle or human-operated vehicle, and adjusting the one or more parameters comprises:
modifying, by the computing system, a route the autonomous vehicle or human-operated vehicle travels to transport the user from the origin location to the departing transportation node.

14. The computer-implemented method of claim 11, wherein determining the uncertainty associated with the estimated time-of-arrival of the user at the departing transportation node comprises:
determining, by the computing system, a time difference between the estimated time-of-arrival and a departure time for a second transportation service associated with the second leg of the multi-modal transportation itinerary; and
determining, by the computing system, the uncertainty based, at least in part, on the time difference.

15. The computer-implemented method of claim 14, wherein when the time difference is greater than a threshold value, determining the one or more modifications to the multi-modal transportation itinerary comprises:
determining, by the computing system, one or more modifications to the second leg of the multi-modal transportation itinerary, the one or more modifications comprising updating the second transportation service to a later service to accommodate the uncertainty in the estimated time-of-arrival of the user at the departing transportation node.

16. The computer-implemented method of claim 15, wherein when the time difference is less than the threshold value, determining one or more modifications to the second leg of the multi-modal transportation itinerary comprises:
delaying a departure time of the second transportation service to accommodate the uncertainty in the estimated time-of-arrival of the user at the departing transportation node.

17. The computer-implemented method of claim 15, wherein the threshold value is based at least in part on a status of one or more other users associated with a vehicle of the second leg of the multi-modal transportation itinerary.

18. The computer-implemented method of claim 9, wherein the data associated with the multi-modal transportation itinerary comprises a type of transportation modality of the first transportation service.

19. The computer-implemented method of claim 18, wherein the type of transportation modality comprises an autonomous vehicle or a human-operated vehicle.

20. One or more tangible, non-transitory computer readable media storing computer-readable instructions that, when executed by one or more processors, cause the one or more processors to perform operations, the operations comprising:
obtaining an initial candidate multi-modal transportation itinerary for a user, the initial candidate multi-modal transportation itinerary comprising a first leg, a second leg, and a third leg, the first leg comprising a first transportation service associated with transporting the user from an origin location to a departing transportation node, the second leg comprising a second transportation service associated with transporting the user from the departing transportation node to a destination transportation node, the third leg comprising a third transportation service associated with transporting the user from the destination transportation node to a destination location;
determining an uncertainty associated with at least one leg of the initial candidate multi-modal transportation itinerary;
determining one or more modifications to the initial candidate multi-modal transportation itinerary based, at least in part, on the uncertainty associated with the at least one leg of the initial candidate multi-modal transportation itinerary, the one or more modifications comprising adjusting a type of transportation modality associated with the first transportation service or the second transportation service;
generating an updated candidate multi-modal transportation itinerary for the user based at least in part on the one or more modifications to the initial candidate multi-modal transportation itinerary; and
communicating, to a user device, data associated with the updated candidate multi-modal transportation itinerary.
